(19) United States
(12) Patent Application Publication
(10) Pub. No.: US 2024/0399733 A1
(43) Pub. Date: Dec. 5, 2024

(54) SHEET PROCESSING APPARATUS AND IMAGE FORMING SYSTEM INCORPORATING THE SHEET PROCESSING APPARATUS

(71) Applicants: Hirofumi HORITA, Kanagawa (JP); Ryohsuke AKAISHI, Kanagawa (JP); Yasunobu KIDOURA, Kanagawa (JP); Satoshi KUNO, Tokyo (JP); Naohiro YOSHIDA, Kanagawa (JP)

(72) Inventors: Hirofumi HORITA, Kanagawa (JP); Ryohsuke AKAISHI, Kanagawa (JP); Yasunobu KIDOURA, Kanagawa (JP); Satoshi KUNO, Tokyo (JP); Naohiro YOSHIDA, Kanagawa (JP)

(73) Assignee: Ricoh Company, Ltd., Tokyo (JP)

(21) Appl. No.: 18/675,525

(22) Filed: May 28, 2024

(30) Foreign Application Priority Data
May 29, 2023 (JP) 2023-087659

(51) Int. Cl. B32B 43/00; B32B 37/06; B32B 38/18; B32B 41/00

(52) U.S. Cl. CPC B32B 43/006; B32B 37/06; B32B 38/1833; B32B 38/1866; B32B 41/00; B32B 2250/03

(57) ABSTRACT

A sheet processing apparatus includes a main conveyance passage, a first branched conveyance passage in a first direction, a second branched conveyance passages in a second direction, a sheet separation device, and a winder. The sheet separation device conveys a first sheet to the first branched conveyance passage, and a second sheet to the second branched conveyance passage to rotate and wind one of the first sheet and the second sheet. The winder is disposed on at least one of the first or second branched conveyance passage and includes a gripper attached to the winder to grip a leading end, in one of first and second directions, of one of the first and second sheets conveyed to corresponding one of the first and second branched conveyance passages.

### CROSS-REFERENCE TO RELATED APPLICATION

This patent application is based on and claims priority pursuant to 35 U.S.C. § 119(a) to Japanese Patent Application No. 2023-087659, filed on May 29, 2023, in the Japan Patent Office, the entire disclosure of which is hereby incorporated by reference herein.

### BACKGROUND

### Technical Field

Embodiments of the present disclosure relate to a sheet processing apparatus that separates the non-bonding portion of a two-ply sheet in which two sheets are overlapped and bonded together at the bonding portion of the two-ply sheet, and an image forming system including the sheet processing apparatus.

### Background Art

Various types of sheet processing apparatuses in the related art are known that separate a two-ply sheet in which two sheets are overlapped and bonded together at one ends as a bonding portion and insert an inner sheet between the two sheets separated from each other.

Specifically, a sheet processing apparatus in the related art separates (peels), to some extent, two sheets of a laminated sheet (e.g., a two-ply sheet) in which one sides of the two sheets are bonded at sheet of the laminated sheet, conveys one of the two sheets (first sheet) to a first branched conveyance passage (branched conveyance), then conveys the other of the two sheets (second sheet) to a second branched conveyance passage (branched conveyance), so that the two sheets are largely separated. Then, an inner sheet is inserted between the two sheets thus largely separated from each other.

### SUMMARY

Embodiments of the present disclosure described herein provide a novel sheet processing apparatus including a main conveyance passage, a first branched conveyance passage, a second branched conveyance passage, a sheet separation device, and a winder. The main conveyance passage conveys a two-ply sheet having two sheets overlapped and bonded together at a bonding portion in a conveyance direction. The first branched conveyance passage is branched from the main conveyance passage in a first direction. The second branched conveyance passage is branched from the main conveyance passage in a second direction different from the first direction. The sheet separation device separates a non-bonding portion of the two-ply sheet, conveys a first sheet of the two sheets separated from each other to the first branched conveyance passage, and conveys a second sheet of the two sheets separated from each other to the second branched conveyance passage. The winder is disposed on at least one of the first branched conveyance passage or the second branched conveyance passage to rotate and wind one of the first sheet and the second sheet. The winder includes a gripper attached to the winder to grip a leading end, in one of the first direction or the second direction, of one of the first sheet and the second sheet conveyed to corresponding one of the first branched conveyance passage and the second branched conveyance passage by the sheet separation device.

Further, embodiments of the present disclosure described herein an image forming system the above-described sheet processing apparatus, and an image forming apparatus to form an image on an inner sheet to be conveyed to the sheet processing apparatus.

Further, embodiments of the present disclosure described herein a sheet laminator including the above-described sheet processing apparatus, and a thermal fixer to perform a sheet laminating operation on the two-ply sheet having an inner sheet inserted between the two sheets by the sheet separation device.

Further, embodiments of the present disclosure described herein an image forming system including the above-described sheet laminator, and an image forming apparatus to form an image on an inner sheet to be conveyed to the sheet laminator.

### BRIEF DESCRIPTION OF THE SEVERAL VIEWS OF THE DRAWINGS

Exemplary embodiments of this disclosure will be described in detail based on the following figures, wherein:

FIG. 1 is a schematic diagram illustrating an overall configuration of a sheet processing apparatus according to an embodiment of the present disclosure;

FIG. 2 is a diagram illustrating sheet separation performed by a sheet separation device included in the sheet processing apparatus of FIG. 1;

FIG. 3 is a schematic diagram illustrating sheet separation performed by the sheet separation device, subsequent from the sheet separation of FIG. 2;

FIG. 4 is a schematic diagram illustrating sheet separation performed by the sheet separation device, subsequent from the sheet separation of FIG. 3;

FIG. 5 is a schematic diagram illustrating sheet separation performed by the sheet separation device, subsequent from the sheet separation of FIG. 4;

FIG. 6 is a schematic diagram illustrating sheet separation performed by the sheet separation device, subsequent from the sheet separation of FIG. 5;

FIG. 7 is a schematic diagram illustrating sheet separation performed by the sheet separation device, subsequent from the sheet separation of FIG. 6;

FIG. 8 is a schematic diagram illustrating sheet separation performed by the sheet separation device, subsequent from the sheet separation of FIG. 7;

FIG. 9 is a schematic diagram illustrating sheet separation performed by the sheet separation device, subsequent from the sheet separation of FIG. 8;

FIG. 10 is a schematic diagram illustrating sheet separation performed by the sheet separation device, subsequent from the sheet separation of FIG. 9;

FIG. 11 is a schematic diagram illustrating sheet separation performed by the sheet separation device, subsequent from the sheet separation of FIG. 10;

FIG. 12 is a schematic diagram illustrating sheet separation performed by the sheet separation device, subsequent from the sheet separation of FIG. 11;

FIG. 13 is a schematic diagram illustrating sheet separation performed by the sheet separation device, subsequent from the sheet separation of FIG. 12;

FIG. 14 is a schematic diagram illustrating sheet separation performed by the sheet separation device, subsequent from the sheet separation of FIG. 13;

FIG. 15 is a schematic diagram illustrating sheet separation performed by the sheet separation device, subsequent from the sheet separation of FIG. 14;

FIG. 16 is a schematic diagram illustrating sheet separation performed by the sheet separation device, subsequent from the sheet separation of FIG. 15;

FIG. 17 is a schematic diagram illustrating sheet separation performed by the sheet separation device, subsequent from the sheet separation of FIG. 16;

FIG. 18 is a perspective view of a separation member;

FIGS. 19A and 19B are schematic view of a driving mechanism to move the separation members;

FIG. 20 is a perspective view of the separation members performing an operation;

FIG. 21 is a perspective view of the separation members performing an operation subsequent from the operation of FIG. 20;

FIG. 22 is a perspective view of the separation members performing an operation subsequent from the operation of FIG. 21;

FIGS. 23A, 23B, and 23C are diagrams illustrating various types of two branched conveyance passages;

FIG. 24 is a diagram illustrating an overall configuration of a sheet processing apparatus (sheet laminator) including a sheet lamination device;

FIG. 25 is a diagram illustrating an overall configuration of an image forming system including the sheet processing apparatus (sheet laminator) illustrated in FIG. 24;

FIG. 26 is a diagram illustrating an image forming system according to another embodiment of the present disclosure;

FIG. 27 is a diagram illustrating an image forming system according to yet another embodiment of the present disclosure;

FIG. 28 is a diagram illustrating an image forming system according to yet another embodiment of the present disclosure;

FIG. 29 is a block diagram illustrating a hardware configuration of a control block of the sheet laminator to control the operation of the sheet laminator;

FIG. 30 including FIGS. 30A, 30B and 30C is a flowchart of a flow of a control process executed in the sheet processing apparatus;

FIGS. 31A and 31B are enlarged views of an area including a branched conveyance passage;

FIGS. 32A and 32B are diagrams illustrating operations of a take-up roller (winder) disposed in the branched conveyance passage of FIGS. 31A and 31B;

FIGS. 33A and 33B are diagrams illustrating operations of the take-up roller, subsequent from the operations of FIGS. 32A and 32B;

FIGS. 34A and 34B are perspective views, each illustrating the operation of a driving mechanism of the take-up roller; and

FIGS. 35A, 35B, and 35C are diagrams, each illustrating the operation of the take-up roller (winder) according to a modification of the above embodiments.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

It will be understood that if an element or layer is referred to as being “on,” “against,” “connected to” or “coupled to” another element or layer, then it can be directly on, against, connected or coupled to the other element or layer, or intervening elements or layers may be present. In contrast, if an element is referred to as being “directly on,” “directly connected to” or “directly coupled to” another element or layer, then there are no intervening elements or layers present. As used herein, the term “connected/coupled” includes both direct connections and connections in which there are one or more intermediate connecting elements. Like numbers refer to like elements throughout. As used herein, the term “and/or” includes any and all combinations of one or more of the associated listed items.

Spatially relative terms, such as “beneath,” “below,” “lower,” “above,” “upper” and the like may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements describes as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors herein interpreted accordingly.

The terminology used herein is for describing particular embodiments and examples and is not intended to be limiting of exemplary embodiments of this disclosure. As used herein, the singular forms “a,” “an,” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

Embodiments of the present disclosure are described below in detail with reference to the drawings. In the drawings, the same or corresponding parts are denoted by the same reference numerals, and redundant description thereof are simplified or omitted as appropriate.

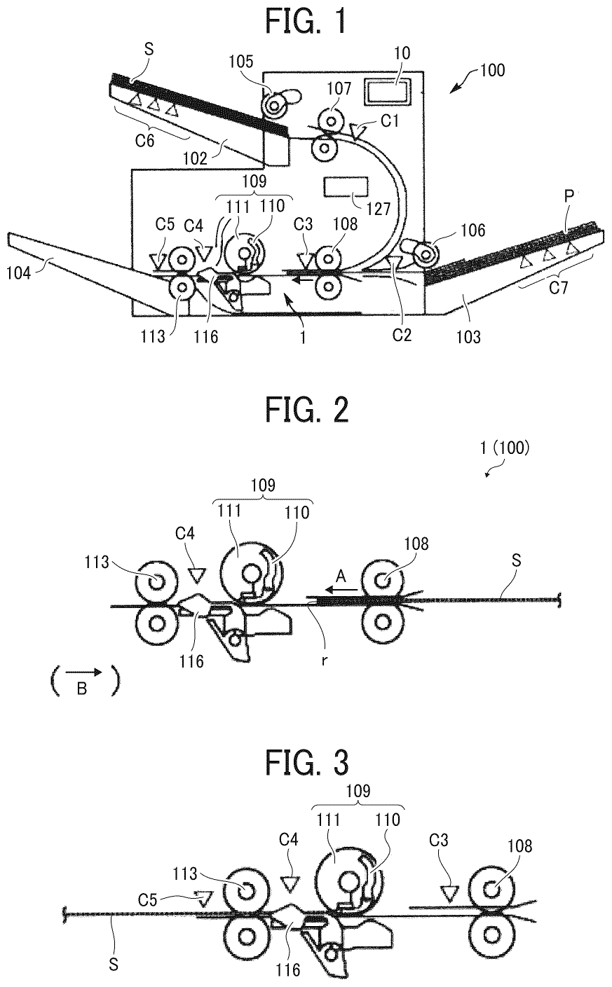

A description is given of a sheet processing apparatus according to an embodiment of the present disclosure, with reference to FIG. 1.

FIG. 1 is a schematic diagram illustrating an overall configuration of a sheet processing apparatus according to an embodiment of the present disclosure.

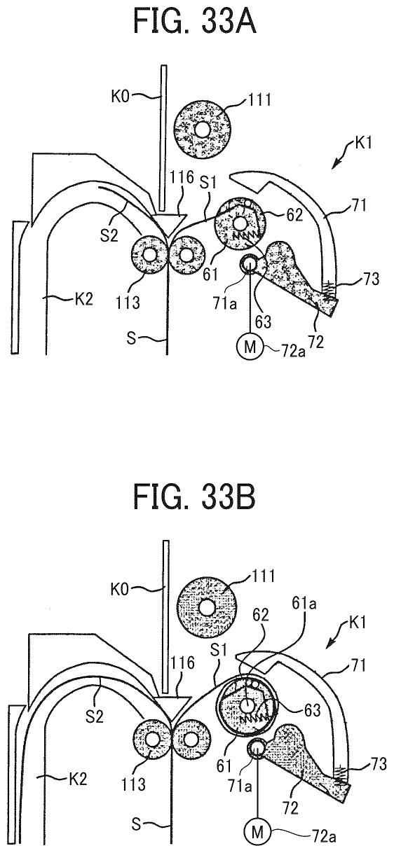

A sheet processing apparatus 100 according to the present embodiment is to separate two sheets of a two-ply sheet and to insert and nip (sandwich) a sheet-shaped medium between the two sheets separated from each other. The two sheets include a first sheet S1 and a second sheet S2 (see the drawings including FIGS. 33A and 33B). The two-ply sheet is referred to as a lamination sheet S and the sheet-shaped medium is referred to as an inner sheet P.

The lamination sheet S is a two-ply sheet in which two sheets are overlapped and bonded together at a portion (or a side) of the two-ply sheet. In other words, the lamination sheet S is a two-ply sheet in which two sheet are overlapped and bonded together at a bonding portion of the two-ply sheet. For example, the lamination sheet S (two-ply sheet) has two sheets (two sides). A first side of the lamination sheet S functions as a transparent sheet such as a transparent polyester sheet, a second side of the lamination sheet S functions as a transparent or opaque sheet disposed facing the first side, and the first and second sides are bonded at one side of the lamination sheet S. The lamination sheet S (two-ply sheet) also includes a lamination film.

The inner sheet P (insertion sheet) is a sheet medium to be inserted into the lamination sheet S (two-ply sheet), between the first sheet S1 and the second sheet S2 of the lamination sheet S. Examples of the sheet medium include plain paper, thick paper, postcards, envelopes, thin paper, coated paper, art paper, tracing paper, and overhead projector (OP) transparencies.

As illustrated in FIG. 1, the sheet processing apparatus 100 includes a sheet tray 102, a pickup roller 105, and a conveyance roller pair 107. The sheet tray 102 functions as a first stacker on which the lamination sheet S is placed. The pickup roller 105 feeds the lamination sheet S from the sheet tray 102. The sheet processing apparatus 100 further includes a sheet tray 103 as a second stacker on which the inner sheet P is stacked, and a pickup roller 106 that feeds the inner sheet P from the sheet tray 103.

The sheet tray 102 includes a sheet size sensor C6 that functions as a sheet size detector to detect the size of the lamination sheet S, in other words, the length of the lamination sheet S in the sheet conveyance direction. The sheet tray 103 includes a sheet size sensor C7 that serves as a medium size detector to detect the size of the inner sheet P, in other words, the length of the inner sheet P in the sheet conveyance direction.

Each of the sheet size sensor C6 and the sheet size sensor C7 includes multiple sensors arranged side by side in the sheet conveyance direction. Since the detection results of the sensors change depending on the size of the stacked lamination sheets S (or the inner sheet P), the sheet size sensors C6 and C7 can detect the length of the lamination sheet S (or the inner sheet P) in the sheet conveyance direction.

A conveyance sensor C1 is disposed downstream from the conveyance roller pair 107 in the sheet conveyance direction to detect the sheet conveyance position of the lamination sheet S.

A conveyance sensor C2 is disposed downstream from the pickup roller 106 in the sheet conveyance direction to detect the sheet conveyance position of the inner sheet P.

The sheet conveyance sensors C1 and C2 may be used to detect the length of the lamination sheet S (or the inner sheet P) in the sheet conveyance direction.

The sheet processing apparatus 100 further includes an entrance roller pair 108 as a first conveyor, a winding roller 109 as a rotator, an exit roller pair 113 as a second conveyor, and a sheet ejection tray 104. The entrance roller pair 108, the winding roller 109, the exit roller pair 113, and the sheet ejection tray 104 are disposed downstream from the conveyance roller pair 107 and the pickup roller 106 in the sheet conveyance direction. The exit roller pair 113 functions as a conveyance roller pair. The sheet processing apparatus 100 further includes separation members 116 between the winding roller 109 and the exit roller pair 113. Each of the separation members 116 is movable in the width direction of the lamination sheet S.

A sheet conveyance sensor C3 is disposed downstream from the entrance roller pair 108 in the sheet conveyance direction to detect the conveyance position of the lamination sheet S and the sheet conveyance position of the inner sheet P.

An abnormal condition detection sensor C4 is disposed downstream from the winding roller 109 in the sheet conveyance direction to detect the condition of the lamination sheet S.

A sheet conveyance sensor C5 is disposed downstream from the exit roller pair 113 as a conveyance roller pair in the sheet conveyance direction to detect the conveyance position of the lamination sheet S.

Each of the pickup roller 105, the conveyance roller pair 107, the entrance roller pair 108, and the winding roller 109 functions as a first sheet feeder, and each of the pickup roller 106, the entrance roller pair 108, and the winding roller 109 functions as a second sheet feeder.

A control panel 10 is provided on the exterior of the sheet processing apparatus 100. The control panel 10 serves as an operation device or a display-operation device to display information of the sheet processing apparatus 100 and receives input of the operation of the sheet processing apparatus 100. The control panel 10 also serves as a notification device to output a perceptual signal to a user. As an alternative, a notification device other than the control panel 10 may be separately provided in the sheet processing apparatus 100.

The sheet processing apparatus 100 according to the present embodiment stacks lamination sheets S and inner sheets P on separate trays. When a lamination sheet S is being conveyed, the sheet processing apparatus 100 separates and opens the lamination sheet S into two sheets, which are the first sheet S1 and the second sheet S2, and inserts the inner sheet P between the first sheet S1 and the second sheet S2 of the lamination sheet S. The exit roller pair 113 ejects and stacks the lamination sheet S, in which the sheet P has been inserted, onto the sheet ejection tray 104.

FIG. 2 is a diagram illustrating the main part (the sheet separation device 1) of the sheet processing apparatus 100 of FIG. 1.

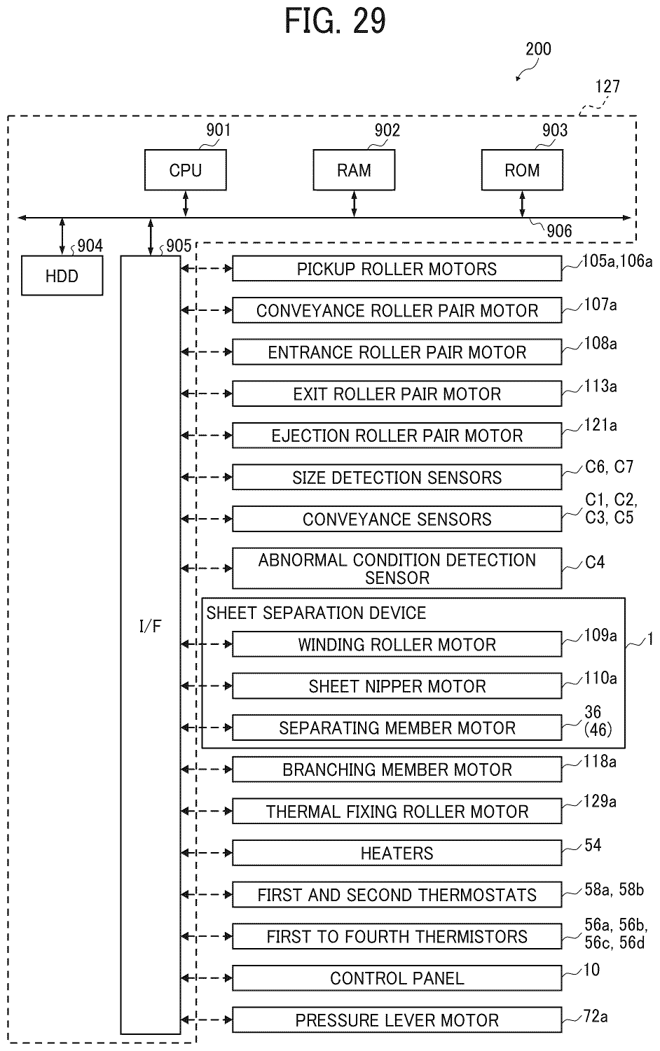

As illustrated in FIG. 2, each of the entrance roller pair 108 and the exit roller pair 113 is, for example, two rollers paired with each other and driven by a driver such as a motor. Specifically, the entrance roller pair 108 is driven and rotated by an entrance roller pair motor 108a serving as a driver (see FIG. 29), and the exit roller pair 113 is driven and rotated by an exit roller pair motor 113a (see FIG. 29). The entrance roller pair 108 rotates in one direction. The exit roller pair 113 rotates in forward and reverse directions. By so doing, the lamination sheet S and the inner sheet P are nipped and conveyed.

The entrance roller pair 108 conveys the lamination sheet S and the inner sheet P toward the exit roller pair 113. The sheet conveyance direction indicated by arrow Ain FIG. 2 is hereinafter referred to as a “forward conveyance direction” or a sheet conveyance direction A.

On the other hand, the exit roller pair 113 can switch the direction of rotation between the forward conveyance direction and a direction opposite to the forward conveyance direction. The exit roller pair 113 conveys the lamination sheet S nipped by the rollers of the exit roller pair 113 toward the sheet ejection tray 104 (see FIG. 1) in the forward conveyance direction and also conveys the lamination sheet S toward the winding roller 109 in the direction opposite the forward conveyance direction (to convey the lamination sheet S in reverse). The sheet conveyance direction of the lamination sheet S toward the winding roller 109 (in other words, the direction opposite to the forward conveyance direction) indicated by arrow B in FIG. 2 is hereinafter referred to as a reverse conveyance direction or a sheet conveyance direction B.

The sheet processing apparatus 100 further includes a sheet separation device 1 between the entrance roller pair 108 and the exit roller pair 113. The sheet separation device 1 includes the winding roller 109 functioning as a rotary member or a rotator and the separation members 116. The winding roller 109 is driven by a winding roller motor 109a (see FIG. 29) to rotate in the forward and reverse conveyance directions. The direction of rotation of the winding roller 109 is switchable between the forward conveyance direction (clockwise direction) and the reverse conveyance direction (counterclockwise direction).

The winding roller 109 includes a roller 111 and a sheet gripper 110 movably disposed on the roller 111 to grip the lamination sheet S. The sheet gripper 110 is driven by a sheet gripper motor 110a (see FIG. 29) to be rotatable with the roller 111. The sheet gripper 110 is movable and grips the leading end of the lamination sheet S with the roller 111. In the present embodiment, the sheet gripper 110 and the roller 111 are separate units. However, the sheet gripper 110 may be formed on the outer circumference of the roller 111 as a single unit.

A description is now given of a series of operations performed in the sheet processing apparatus 100, with reference to FIGS. 1 to 17.

FIGS. 3 to 17 are schematic diagrams illustrating a series of sheet separation performed by the sheet separation device 1.

The series of operations performed in the sheet processing apparatus 100 indicates the operations from separating the lamination sheet S to inserting the inner sheet P into the lamination sheet S.

In FIGS. 3 to 17, elements identical to those illustrated in FIG. 1 or 2 are given identical reference numerals, and the descriptions thereof are omitted.

In FIG. 1, the lamination sheet S is loaded on the sheet tray 102 such that a part of the bonded side of the lamination sheet S is located downstream from the pickup roller 105 in the sheet feed direction (sheet conveyance direction). In the sheet processing apparatus 100, the pickup roller 105 picks up the lamination sheet S from the sheet tray 102, and the conveyance roller pair 107 conveys the lamination sheet S toward the entrance roller pair 108.

As illustrated in FIG. 2, the entrance roller pair 108 conveys the lamination sheet S toward the winding roller 109. In the sheet processing apparatus 100, the entrance roller pair 108 conveys the lamination sheet S with the bonded end, which is one of four sides of the lamination sheet S, as the downstream side in the forward conveyance direction A as indicated by arrow A in FIG. 2.

Subsequently, as illustrated in FIG. 3, the sheet processing apparatus 100 temporarily stops conveyance of the lamination sheet S when the trailing end of the lamination sheet S in the forward conveyance direction has passed the winding roller 109. These operations are performed by conveying the lamination sheet S from the sheet conveyance sensor C3 by a designated amount in response to the timing at which the sheet conveyance sensor C3 detects the leading end of the lamination sheet S.

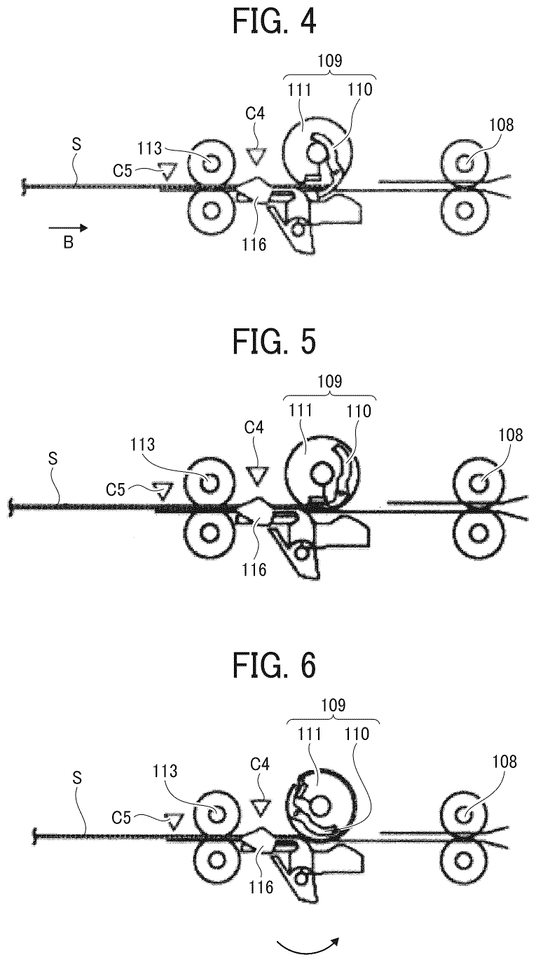

As illustrated in FIG. 4, the sheet processing apparatus 100 causes the sheet gripper 110 to open and the exit roller pair 113 to rotate in the reverse direction to convey the lamination sheet S in the reverse conveyance direction (i.e., the reverse conveyance direction B) toward an opening portion of the sheet gripper 110.

Subsequently, as illustrated in FIG. 5, the sheet processing apparatus 100 stops conveyance of the lamination sheet S when the trailing end of the lamination sheet S is inserted into the opening portion of the sheet gripper 110, and causes the sheet gripper 110 to close and grip the trailing end of the lamination sheet S. These operations are performed when the lamination sheet S is conveyed by the designated amount.

Then, as illustrated in FIG. 6, the sheet processing apparatus 100 causes the driver to rotate the winding roller 109 in the counterclockwise direction in FIG. 6 to wind the lamination sheet S around the winding roller 109. The lamination sheet S is wound around the winding roller 109 from the side where the two sheets of the lamination sheet S are overlapped but not bonded.

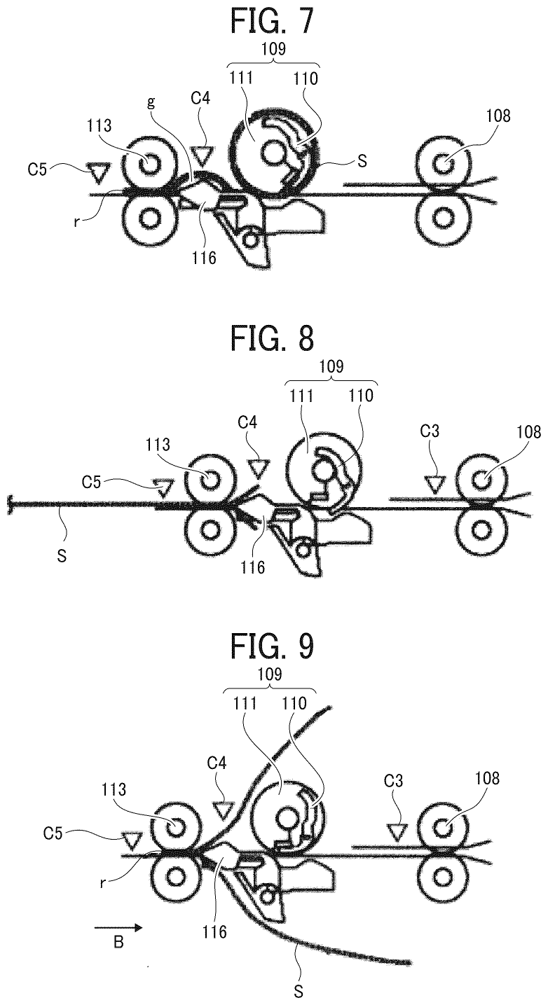

As illustrated in FIG. 7, when the lamination sheet S is wound around the winding roller 109, a winding circumferential length difference is created between the two sheets in the amount of winding of the lamination sheet S (i.e., two-ply sheet) around the circumference of the winding roller 109. There is a surplus of the sheet on the inner circumferential side to the center of the winding roller 109, which generates a slack toward the bonded end. As a result, a space g (slack) is created between the two sheets of the lamination sheet S. As the separation members 116 are inserted into the space g formed as described above, from opposed sides of the lamination sheet S, the space g between the two sheets is reliably maintained. In response to the detection of the leading end of the lamination sheet S with the sheet conveyance sensor C5, the lamination sheet S is conveyed from the sheet conveyance sensor C5 by a designated amount to perform these operations.

A description is now given of the separation members 116.

FIG. 18 is a schematic view of the separation member 116 included in the sheet processing apparatus 100.

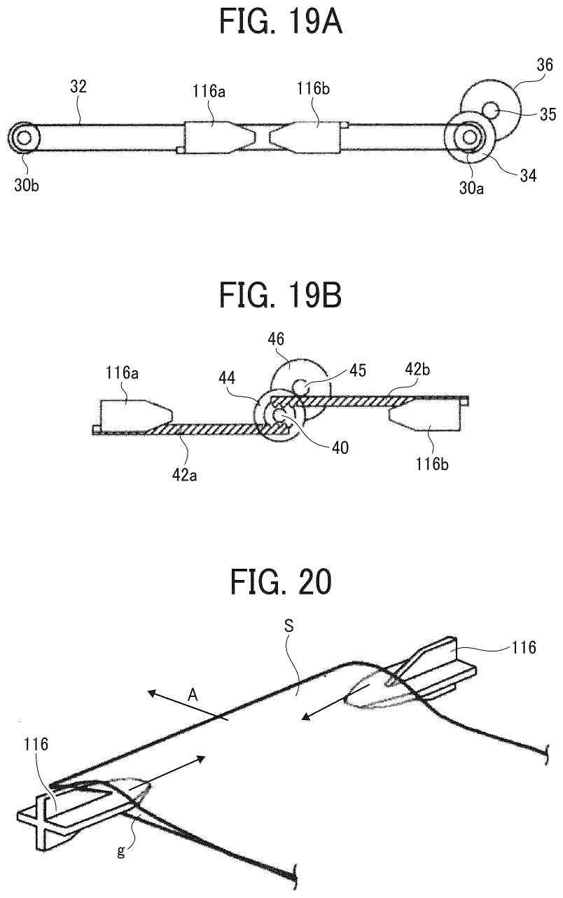

FIGS. 19A and 19B are schematic views, each illustrating an example of a driving mechanism of the separation members 116.

Further, FIG. 20 is a perspective view of a state in which the separation members 116 are inserted into the lamination sheet S.

As illustrated in FIG. 18, when viewed from the upstream side in the sheet conveyance direction, the size in the height (vertical direction) of the separation members 116 gradually increases from the center in the width direction to the trailing end (right end in FIG. 18). Further, when viewed from the vertical direction, the size of the separation member 116 in the sheet conveyance direction gradually increases from the leading end to the center. When viewed from the width direction, the separation member 116 has a cross shape. Each separation members 116 further has a branching member that functions as a guide to guide the two sheets separated from the lamination sheet S in different directions due to the above-described cross shape.

Further, in the present embodiment, referring to FIGS. 19A and 19B, the two separation members 116 are disposed facing each other and moved in the approaching direction and the separating direction, for example, by a belt drive mechanism as illustrated in FIG. 19A and by a rack and pinion mechanism illustrated in FIG. 19B.

More specifically, the belt drive mechanism illustrated in FIG. 19A includes a belt 32 stretched between a drive pulley 30a and a driven pulley 30b and the two separation members 116a and 116b are attached to the belt 32 while facing each other. The separation member 116a is attached and connected to the lower part of the belt 32 and the separation member 116b is attached and connected to the upper part of the belt 32.

The drive pulley 30a is provided with a drive transmission gear 34. The rotational output of a separation member motor 36 is transmitted to the drive transmission gear 34 via a motor output gear 35. In other words, the rotational output of the separation member motor 36 is transmitted to the belt 32.

As a result, as the separation member motor 36 is rotated in the clockwise direction (when viewed from the front of the drawing), the separation members 116a and 116b are moved toward each other. By contrast, as the separation member motor 36 is rotated in the counterclockwise direction (when viewed from the front of the drawing), the separation members 116a and 116b are moved away from each other.

The rack and pinion mechanism illustrated in FIG. 19B includes two racks 42a and 42b extending in opposite directions from each other. Each of the racks 42a and 42b meshes with a single pinion 40. The separation member 116a that is attached to the rack 42a faces the separation member 116b that is attached to the rack 42b. The pinion 40 is provided with a drive transmission gear 44. The rotational output of a separation member motor 46 is transmitted to the drive transmission gear 44 via a motor output gear 45. The rotational output of the separation member motor 46 is transmitted to the racks 42a and 42b, respectively.

As a result, as the separation member motor 46 is rotated in the clockwise direction (when viewed from the front of the drawing), the separation members 116a and 116b are moved toward each other. By contrast, as the separation member motor 46 is rotated in the counterclockwise direction (when viewed from the front of the drawing), the separation members 116a and 116b are moved away from each other.

As described above, in the present embodiment, each of the separation members 116a and 116b has the above-mentioned shape and is movable in the width direction of the lamination sheet S. Accordingly, the separation members 116a and 116b are smoothly inserted into the space g created in the lamination sheet S as illustrated in FIG. 20.

The description of a series of operations of the sheet processing apparatus 100 is continued below. With the separation members 116 inserted in the space g created in the lamination sheet S (see FIG. 7), the sheet processing apparatus 100 causes the winding roller 109 to rotate in the clockwise direction and shift the space g separating the two sheets of the lamination sheet S to the trailing end of the lamination sheet S in the forward conveyance direction (i.e., the direction indicated by arrow A in FIG. 2), as illustrated in FIG. 8. After the winding roller 109 has been rotated by a designated amount, the sheet processing apparatus 100 causes the sheet gripper 110 to open. As a result, the trailing end of the lamination sheet S is separated into the upper and lower sheets at the trailing end.

In this state, the sheet processing apparatus 100 temporarily stops the conveyance of the lamination sheet S and further moves the separation members 116 in the width direction of the lamination sheet S to separate the whole area of the trailing end of the lamination sheet S.

In response to the detection of the leading end of the lamination sheet S with the sheet conveyance sensor C5, the lamination sheet S is conveyed from the sheet conveyance sensor C5 by a designated amount to perform these operations.

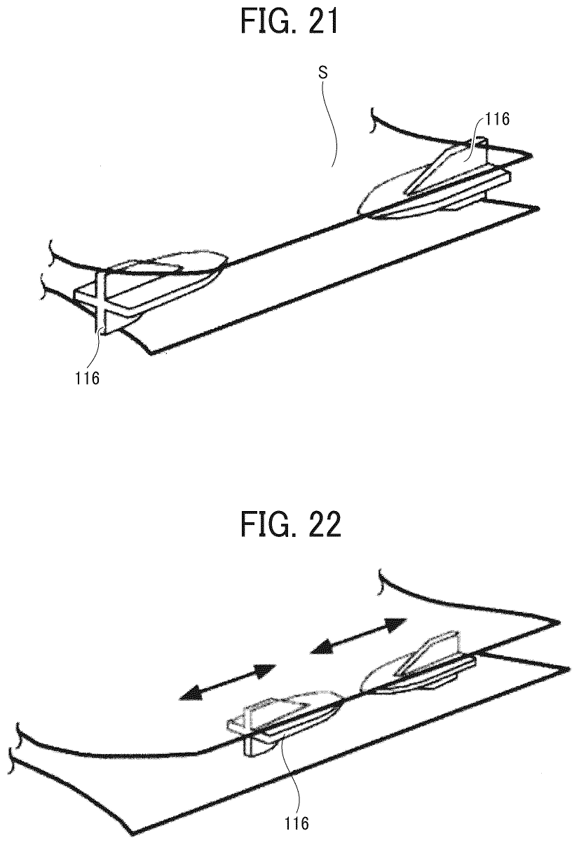

FIG. 21 is a perspective view of the separation members 116 and the lamination sheet S in the state illustrated in FIG. 8.

Since each of the separation members 116 further has a branching guide that functions as a guide to guide the two sheets separated from the lamination sheet S in different directions due to the above-described shape (see the cross shape illustrated in FIG. 18), the two sheets separated from the lamination sheet S may be kept in postures to be conveyed to different sheet conveyance passages.

Further, FIG. 22 is a perspective view of the separation members 116 performing an operation subsequent from the operation of FIG. 21.

Since the separation members 116 are movable in the width direction of the lamination sheet S (see FIGS. 19A and 19B), the separation members 116 are positioned suitably to support the postures of the two sheets of the lamination sheet S as illustrated in FIG. 22. Due to such a configuration, even when the size of the lamination sheet S and the rigidity (or retentivity corresponding to the propensity to retain a particular shape once applied, such as curvature of paper) of the lamination sheet S change, the two sheets separated from the lamination sheet S are guided in desired branching directions. This configuration eliminates the need for a branching member to branch the lamination sheet S over the whole area in the width direction of the sheet conveyance passage and a driver to drive the branching member, thereby reducing the cost when compared with the configuration of a typical sheet processing device.

Subsequently, as illustrated in FIG. 9, after the separation members 116 have separated the whole area of the trailing end of the lamination sheet S, the sheet processing apparatus 100 causes the driver to rotate the exit roller pair 113 in the counterclockwise direction in FIG. 9 to convey the lamination sheet S in the reverse conveyance direction (i.e., the direction indicated by arrow B in FIG. 9). In other words, the separation members 116 guide the two sheets separated from the lamination sheet S vertically, in other words, in the upper and lower directions (to the branched conveyance passages K1 and K2), respectively, and thus the two sheets are fully separated.

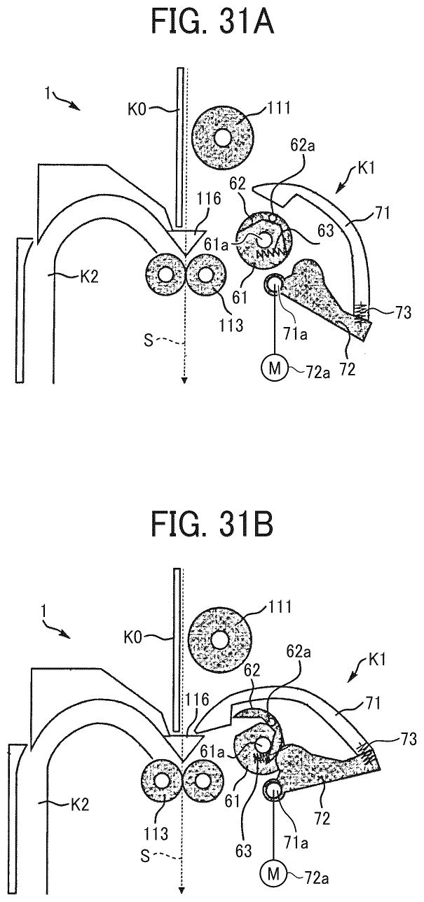

The configuration and operation of each of the branched conveyance passages K1 and K2 according to the present embodiment are described in further detail below, with reference to FIGS. 31A to 34B.

The sheet processing apparatus 100 temporarily stops the conveyance of the lamination sheet S, so that a bonding portion “r” of the lamination sheet S is gripped (nipped) by the exit roller pair 113. Accordingly, one end of the lamination sheet S is bonded as the bonded side of the lamination sheet S and the other end of the lamination sheet S is opened largely.

In response to the detection of the leading end of the lamination sheet S with the sheet conveyance sensor C5, the lamination sheet S is conveyed from the sheet conveyance sensor C5 by a designated amount to perform these operations.

A description is now given of the operation of inserting the inner sheet P into the lamination sheet S between the separated two sheets, which are the first sheet S1 and the second sheet S2.

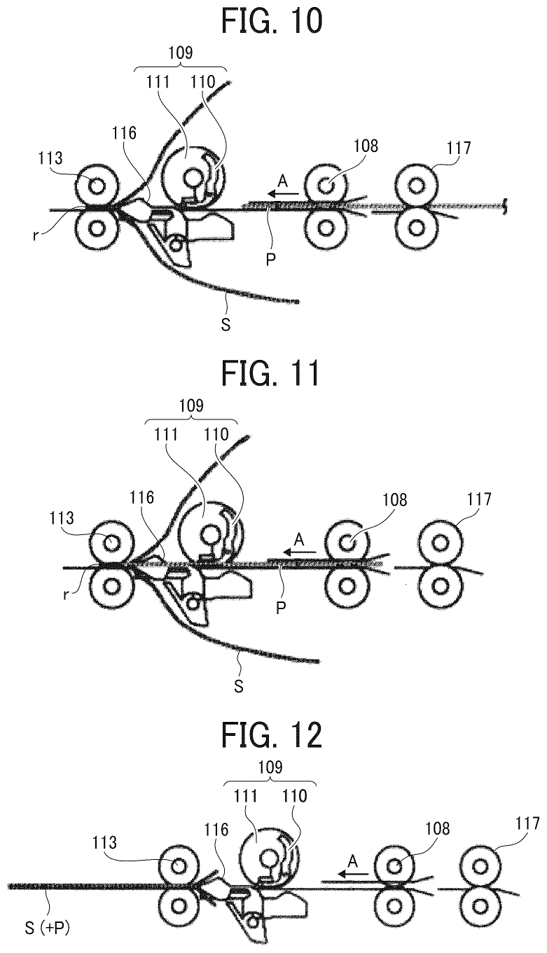

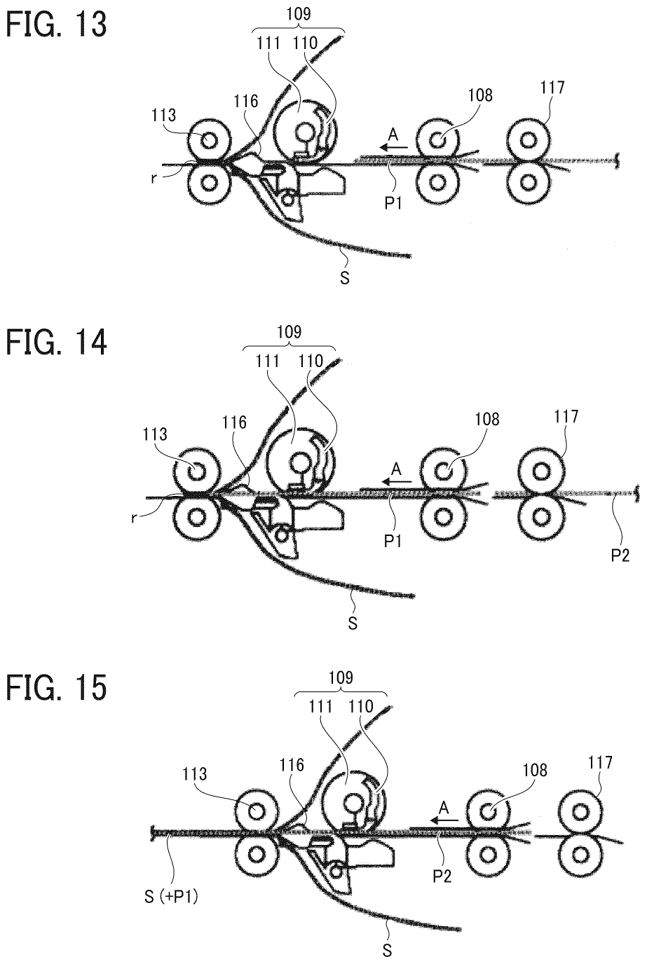

The sheet processing apparatus 100 according to the present embodiment can insert one inner sheet P to multiple inner sheets P into a lamination sheet S depending on the size of the lamination sheet S (i.e., the length of the lamination sheet S in the sheet conveyance direction) and the size of the inner sheet P (i.e., the length of the inner sheet P in the sheet conveyance direction). Firstly, a description is given of a single sheet insertion mode to insert a single inner sheet P into a lamination sheet S, with reference to FIGS. 10 to 12. Then, a description is given of a multiple sheet insertion mode to insert multiple inner sheets P into a lamination sheet S along the sheet conveyance direction, with reference to FIGS. 13 to 16.

### Single Sheet Insertion Mode

FIG. 10 is a schematic diagram illustrating sheet separation performed by the sheet separation device 1 of the sheet processing apparatus 100, subsequent from the sheet separation of FIG. 9.

FIG. 11 is a schematic diagram illustrating sheet separation performed by the sheet separation device 1 of the sheet processing apparatus 100, subsequent from the sheet separation of FIG. 10.

FIG. 12 is a schematic diagram illustrating sheet separation performed by the sheet separation device 1 of the sheet processing apparatus 100, subsequent from the sheet separation of FIG. 11.

As illustrated in FIG. 10, the sheet separation device 1 of the sheet processing apparatus 100 causes the entrance roller pair 108 to rotate to convey the inner sheet P conveyed from the sheet tray 103 (see FIG. 1) toward the exit roller pair 113 in the forward conveyance direction (i.e., the direction indicated by arrow Ain FIG. 10).

Subsequently, as illustrated in FIG. 11, the sheet separation device 1 of the sheet processing apparatus 100 causes the exit roller pair 113 to rotate so that the lamination sheet S and the inner sheet P meet to insert the inner sheet P into the lamination sheet S from the open portion (on the other end) of the lamination sheet S.

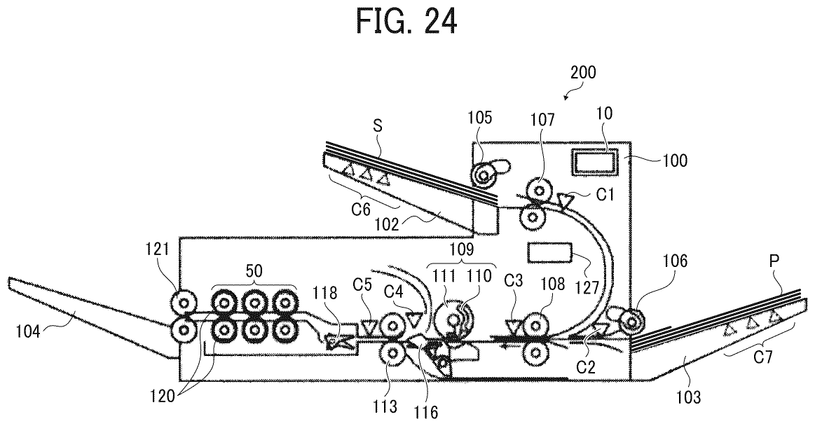

Then, as illustrated in FIG. 12, the exit roller pair 113 of the sheet separation device 1 of the sheet processing apparatus 100 conveys the lamination sheet S in which the inner sheet P is inserted, in the forward conveyance direction (i.e., the direction indicated by arrow A in FIG. 12). Thus, the two sheets of the lamination sheet S are overlapped one on another again so as to close the open portion of the lamination sheet S. Then, the lamination sheet S with the inner sheet P being inserted is ejected by the exit roller pair 113 or the ejection roller pair 121 (see FIG. 24) disposed downstream from the exit roller pair 113 and is placed (stacked) on the sheet ejection tray 104 (see FIG. 1).

### Multiple Sheet Insertion Mode

Then, a description is given of the multiple sheet insertion mode.

FIG. 13 is a schematic diagram illustrating sheet separation performed by the sheet separation device, subsequent from the sheet separation of FIG. 12.

FIG. 14 is a schematic diagram illustrating sheet separation performed by the sheet separation device, subsequent from the sheet separation of FIG. 13.

FIG. 15 is a schematic diagram illustrating sheet separation performed by the sheet separation device, subsequent from the sheet separation of FIG. 14.

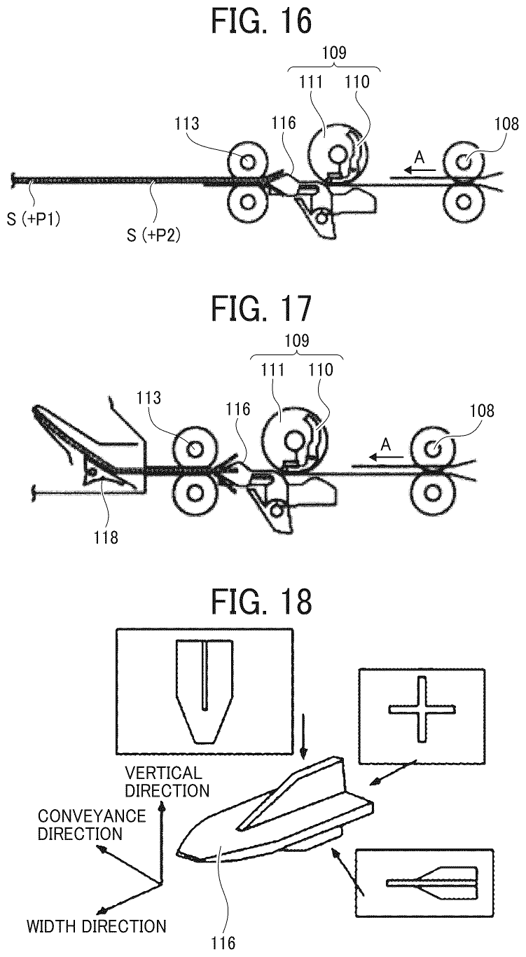

FIG. 16 is a schematic diagram illustrating sheet separation performed by the sheet separation device, subsequent from the sheet separation of FIG. 15.

FIG. 17 is a schematic diagram illustrating sheet separation performed by the sheet separation device, subsequent from the sheet separation of FIG. 16.

In the multiple sheet insertion mode, multiple inner sheets P (two sheets in the present embodiment) are insertable into a single lamination sheet S in the sheet conveyance direction.

Then, as illustrated in FIG. 13, the sheet separation device 1 of the sheet processing apparatus 100 causes the entrance roller pair 108 to rotate to convey a first inner sheet P (referred to as a first inner sheet P1) conveyed from the sheet tray 103 (see FIG. 1) toward the exit roller pair 113 in the forward conveyance direction (i.e., the direction indicated by arrow A in FIG. 2).

Subsequently, as illustrated in FIG. 14, the sheet separation device 1 of the sheet processing apparatus 100 causes the exit roller pair 113 to rotate so that the lamination sheet S and the first inner sheet P1 meet. By so doing, the first inner sheet P1 is inserted into the opening of the lamination sheet S. At this time, the sheet processing apparatus 100 conveys a second inner sheet P (hereinafter, referred to as a second inner sheet P2) conveyed from the sheet tray 103 (see FIG. 1) toward the exit roller pair 113 in the forward conveyance direction (i.e., the direction indicated by arrow A in FIG. 2).

Subsequently, as illustrated in FIG. 15, the sheet separation device 1 of the sheet processing apparatus 100 causes the entrance roller pair 108 to rotate so that the lamination sheet S and the second insertion sheet P2 meet. By so doing, the second inner sheet P2 is inserted into the opening of the lamination sheet S.

As illustrated in FIG. 16, the sheet separation device 1 of the sheet processing apparatus 100 causes the exit roller pair 113 to convey the lamination sheet S, with the first inner sheet P1 and the second inner sheet P2 being inserted, in the forward conveyance direction (i.e., the direction indicated by arrow Ain FIG. 2). By so doing, the two sheets are overlaid one on another again to close the opening of the lamination sheet S.

Even if there are three or more inner sheets P, the three or more inner sheets P can be inserted in the lamination sheet S by repeating the above-described operations.

As an alternative example, in a case where a sheet processing device includes a sheet lamination device (see a thermal fixing roller pair 120 in FIG. 24 of the present embodiment) that can heat and press the lamination sheet S, a branching member 118 may change (switch) the sheet conveyance passage of the lamination sheet S to convey the lamination sheet S to the thermal-pressure device, as illustrated in FIG. 17. Not only in the multiple sheet insertion mode but also in the single sheet insertion mode, the sheet conveyance passage may be changed (switched) with the branching member 118.

As described above, the sheet processing apparatus 100 according to the present embodiment can control the driver and other parts to perform the sheet inserting operation of inner sheets P to be inserted into a lamination sheet S.

A description is now given of a configuration in which the sheet processing apparatus 100 acquires the size of the lamination sheet S (i.e., the length in the sheet conveyance direction of the lamination sheet S), the size of the inner sheet P (i.e., the length in the sheet conveyance direction of the inner sheet P), and the number of the inner sheets P to be inserted into the lamination sheet S.

As illustrated in FIG. 1, the sheet processing apparatus 100 according to the present embodiment includes the sheet size sensor C6 functioning as a sheet size detector and the sheet size sensor C7 functioning as a medium size detector. Based on the detection results of the sheet size sensors C6 and C7, the sheet processing apparatus 100 determines whether the length of the inner sheet P in the sheet conveyance direction is equal to or smaller than the threshold value. When the length of the inner sheet P in the sheet conveyance direction is equal to or smaller than the threshold value, the sheet processing apparatus 100 automatically switches to the multiple sheet insertion mode to perform the sheet inserting operation. On the other hand, when the length of the inner sheet P in the sheet conveyance direction is greater than the threshold value, the sheet processing apparatus 100 automatically switches to the single sheet insertion mode to perform the sheet inserting operation.

In particular, when the length of the inner sheet P in the sheet conveyance direction is equal to or smaller than half the length of the lamination sheet S in the sheet conveyance direction, the sheet processing apparatus 100 may automatically switch to the multiple sheet insertion mode to perform the sheet inserting operation. In the multiple sheet insertion mode, the sheet processing apparatus 100 determines the number of inner sheets P to be inserted into the lamination sheet S from the quotient of the size of the lamination sheet S divided by the size of the inner sheet P.

Instead of or in addition to the detection results of the sheet size sensors C6 and C7, the sheet processing apparatus 100 may use the detection results of the sheet conveyance sensors C1 and C2.

As described above, the sheet processing apparatus 100 according to the present embodiment can automatically control the sheet inserting operation in accordance with the size of the lamination sheet S and the size of the inner sheet P.

Additionally, as illustrated in FIG. 1, the sheet processing apparatus 100 according to the present embodiment can separately stack the lamination sheets S and the inner sheets P on separate trays to be conveyed separately. Accordingly, there is no need to stack the lamination sheets S and the inner sheets P in a predetermined order, and this configuration can enhance the convenience. In the present embodiment, the lamination sheets S are stacked on the sheet tray 102 and the inner sheets P are stacked on the sheet tray 103. However, the tray on which the lamination sheets S are stacked and the tray on which the inner sheets P are stacked are not limited to the above-described trays. For example, the inner sheets P may be stacked on the sheet tray 102 and the lamination sheets S may be stacked on the sheet tray 103.

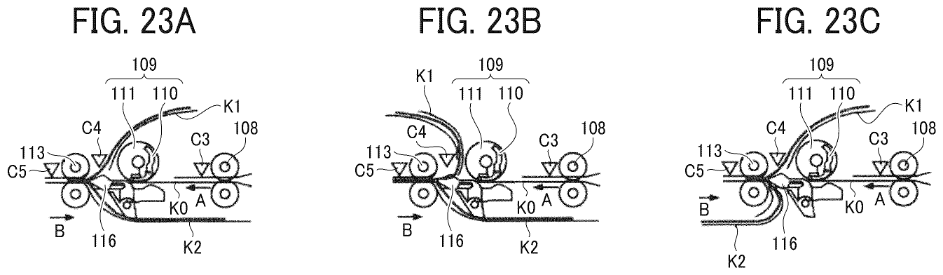

Configuration of Branched Conveyance Passages K1 and K2 FIGS. 23A, 23B, and 23C are diagrams illustrating various types of two branched conveyance passages.

FIGS. 23A, 23B, and 23C depict various forms of the first branched conveyance passage K1 and the second branched conveyance passage K2 (two conveyance passages branched from the main conveyance passage K0 to the upper and lower sides) for the separated two sheets of the lamination sheet S. Specifically, FIG. 23A illustrates a case where the separated two sheets are guided from the bonding portion “r” of the lamination sheet S in the direction opposite to the sheet conveyance direction (i.e., the direction indicated by arrow B in FIG. 23A) to the first branched conveyance passage K1 and the second branched conveyance passage K2, as illustrated in FIG. 9. Alternatively, as illustrated in FIG. 23B, the upper sheet of the separated two sheets of the lamination sheet S may be guided from the bonding portion “r” to the first branched conveyance passage K1 extending in the sheet conveyance direction (i.e., the direction indicated by arrow Ain FIG. 23B) and the lower sheet of the separated two sheets of the lamination sheet S may be guided from the bonding portion “r” to the second branched conveyance passage K2 extending in the direction opposite to the sheet conveyance direction. Further, as illustrated in FIG. 23C, the upper sheet of the separated two sheets of the lamination sheet S may be guided from the bonding portion “r” to the first branched conveyance passage K1 in the direction opposite to the sheet conveyance direction and the lower sheet of the separated two sheets of the lamination sheet S may be guided from the bonding portion “r” to the second branched conveyance passage K2 in the sheet conveyance direction. As illustrated in FIG. 9A, the two sheets separated from each other from the lamination sheet S are branched by the separation members 116 and then guided in the direction opposite to the sheet conveyance direction. However, the two sheets separated from each other from the lamination sheet S may be branched by the separation members 116 and then guided in the sheet conveyance direction.

A description is then given of a sheet laminator including the sheet processing device, and an image forming system including the sheet laminator, according to an embodiment of the present disclosure.

FIG. 24 is a diagram illustrating an overall configuration of a sheet processing apparatus (sheet laminator) including a sheet lamination device 50.

As illustrated in FIG. 24, a sheet laminator 200 includes the sheet processing apparatus 100 described above, the branching member 118, the sheet lamination device 50, and an ejection roller pair 121. The branching member 118 changes (switches) the sheet conveyance passage of the lamination sheet S. The sheet lamination device 50 includes multiple thermal fixing roller pairs 120 and can heat and press the lamination sheet S. The ejection roller pair 121 is disposed downstream from the sheet lamination device 50 (the thermal fixing roller pairs 120) in the sheet conveyance direction.

A sheet laminator (for example, a sheet laminator 200b described below) may include a single thermal fixing roller pair 120.

The sheet laminator 200 performs a series of operations, in this order, of feeding the lamination sheet S, separating the lamination sheet S, inserting the inner sheet P into the lamination sheet S, and laminating the lamination sheet S with the inner sheet P being inserted, by application of heat and pressure, on a stand-alone basis. This series of operations is carried out automatically without any aid of a user. For this reason, the sheet laminator 200 can enhance and provide the convenience better than a known sheet laminator employing a known technique.

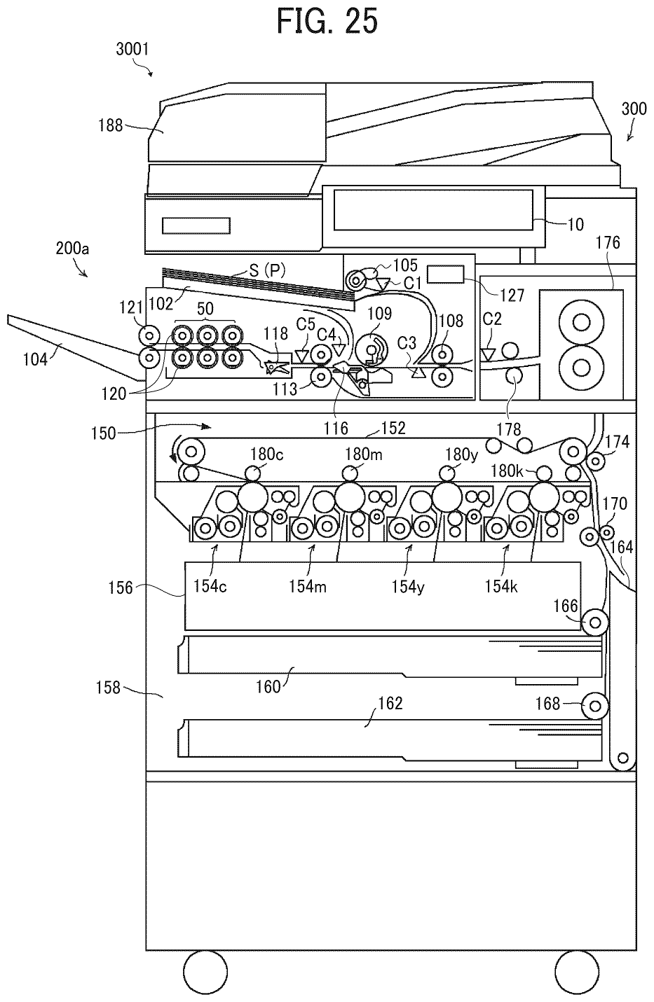

FIG. 25 is a diagram illustrating an overall configuration of an image forming system including the sheet processing apparatus (sheet laminator) illustrated in FIG. 24.

An image forming system 3001 includes a sheet laminator 200a in an in-body sheet discharging section of an image forming apparatus 300. The sheet laminator 200a functions as a device that performs sheet lamination.

The sheet laminator 200a includes the sheet tray 102 on which the lamination sheets S or the inner sheets P are stacked. The sheet laminator 200a can receive the lamination sheets S, the inner sheets P, or both from the image forming apparatus 300. Accordingly, the image forming apparatus 300 (e.g., a printer and a copier) can form an image on the lamination sheet S or the inner sheet P by the in-line connection.

A detailed description is given of the configuration of the image forming apparatus 300. As illustrated in FIG. 25, the image forming apparatus 300 includes an intermediate transfer device 150. The intermediate transfer device 150 includes an intermediate transfer belt 152 having an endless loop and being entrained around a plurality of rollers and stretched substantially horizontally. The intermediate transfer belt 152 rotates in the counterclockwise direction in FIG. 33.

The image forming apparatus 300 further includes image forming units 154c, 154m, 154y, and 154k for cyan (C), magenta (M), yellow (Y), and black (K), respectively. The image forming units 154c, 154m, 154y, and 154k are disposed below the intermediate transfer device 150 in the housing of the image forming apparatus 300. The image forming units 154c, 154m, 154y, and 154k are aligned in a quadruple tandem manner along an extended direction of the intermediate transfer belt 152. Each of the image forming units 154c, 154m, 154y, and 154k includes a drum-shaped image bearer that rotates in the clockwise direction in FIG. 25. Various image forming components, for example, a charging unit, a developing unit, a transfer unit, and a cleaning unit, are disposed around each of the image forming units 154c, 154m, 154y, and 154k. An exposure device 156 is disposed below the image forming units 154c, 154m, 154y, and 154k included in the image forming apparatus 300.

A sheet feeder 158 is disposed below the exposure device 156 in the image forming apparatus 300. The sheet feeder 158 includes a first sheet tray 160 that stores lamination sheets S and a second sheet tray 162 that stores inner sheets P. The first sheet tray 160 functions as a third sheet stacker on which a two-ply sheet such as the lamination sheet S is stacked. Similarly, the second sheet tray 162 functions as a fourth sheet stacker on which a sheet medium (e.g., the inner sheet P) is stacked.

A first feed roller 166 is disposed at a position upper right of the first sheet tray 160. The first feed roller 166 feeds out the lamination sheet S one by one from the first sheet tray 160 to a sheet conveyance passage 164. A second feed roller 168 is disposed at the upper right of the second sheet tray 162 and feeds the inner sheet P from the second sheet tray 162 one by one to the sheet conveyance passage 164.

The sheet conveyance passage 164 extends upwardly from the lower side to the upper side on the right side in the image forming apparatus 300 and communicates with the sheet laminator 200a in the image forming apparatus 300. The sheet conveyance passage 164 is provided with, e.g., a conveyance roller pair 170, a secondary transfer device 174 in contact with the intermediate transfer belt 152, a fixing device 176, and a first sheet ejection device 178 including the ejection roller pair, serially.

The first feed roller 166, the conveyance roller pair 170, and the sheet conveyance passage 164 serve as a third sheet feeder to feed the two-ply sheet (i.e., the lamination sheet S) from the first sheet tray 160 (functioning as a third stacker). The second feed roller 168, the conveyance roller pair 170, and the sheet conveyance passage 164 function as a fourth sheet feeder to feed the sheet medium (i.e., the inner sheet P) from the second sheet tray 162 (functioning as a fourth stacker). Further, the intermediate transfer device 150 and the fixing device 176 function as a part of the image forming device that forms an image on a sheet medium (i.e., the inner sheet P).

A description is now given of operations of the image forming apparatus 300 according to the present embodiment, to form an image on a sheet medium (i.e., the inner sheet P) and then perform a sheet laminating operation on the lamination sheet S.

To perform an image on the sheet medium (i.e., the inner sheet P), first, an image reading device 188 reads the image on an original document, and the exposure device 156 then performs writing of the image on the original document. The image forming units 154c, 154m, 154y, and 154k form respective toner images of cyan (C), magenta (M), yellow (Y), and black (K), respectively, on the respective image bearers. Then, primary transfer devices 180c, 180m, 180y, and 180k sequentially transfer the respective toner images onto the intermediate transfer belt 152, thereby forming a color image on the intermediate transfer belt 152.

By contrast, the image forming apparatus 300 rotates the second feed roller 168 to feed and convey the inner sheet P to the sheet conveyance passage 164. The inner sheet P is conveyed by the conveyance roller pair 170 through the sheet conveyance passage 164 and is sent to the secondary transfer device 174 in synchrony with movement of the color image on the intermediate transfer belt 152. Then, the secondary transfer device 174 transfers the color image formed on the intermediate transfer belt 152 as described above, onto the inner sheet P.

After the color image has been transferred onto the inner sheet P, the fixing device 176 fixes the color image to the inner sheet P, and the first sheet ejection device 178 ejects to convey the inner sheet P to the sheet laminator 200a.

The sheet laminator 200a rotates the pickup roller 105 to pick up the lamination sheet S from the sheet tray 102 on which the lamination sheet S is stacked and conveys the lamination sheet S to the sheet separation device 1 (including the winding roller 109 and the separation members 116). The sheet separation device 1 separates a lamination sheet S into two sheets and conveys an inner sheet P conveyed from the image forming apparatus 300 by the entrance roller pair 108. By so doing, the inner sheet P is inserted between the separated two sheets of the lamination sheet S. Then, the lamination sheet S with the inner sheet P being inserted is conveyed by the exit roller pair 113 to the sheet lamination device 50 (thermal fixer). Then, the sheet laminating operation of the sheet lamination device 50 applies heat and pressure to the lamination sheet S in which the inner sheet P is inserted, in other words, the thermal fixing roller pairs 120 of the sheet lamination device 50 performs a sheet laminating operation on the lamination sheet S with the inner sheet P being inserted.

As described above, the lamination sheet S and the inner sheet P on which an image is formed are conveyed to the sheet laminator 200a to receive the sheet laminating operation performed by the sheet laminator 200a.

According to the above-described configuration of the image forming system 3001 according to the present embodiment, the lamination sheet S stacked on the first sheet tray 160 of the image forming apparatus 300 is conveyed to the sheet laminator 200a via the sheet conveyance passage 164 and separate the lamination sheet S into two sheets in the sheet separation device 1. Then, while the sheet laminator 200a performs a sheet separating operation on the lamination sheet S, the image forming apparatus 300 conveys the inner sheet P stacked on the second sheet tray 162 in the sheet conveyance passage 164, the secondary transfer device 174, the fixing device 176, and the first sheet ejection device 178 to form an image on the inner sheet P, and then conveyed the inner sheet P to the sheet laminator 200a. Then, the sheet laminator 200a may also perform the sheet laminating operation on the lamination sheet S after inserting the inner sheet P on which an image is formed into the lamination sheet S separated into two sheets.

Descriptions are then given of an image forming system including the sheet processing device according to an embodiment of the present disclosure and an image forming apparatus, according to different embodiments of the above-described embodiment.

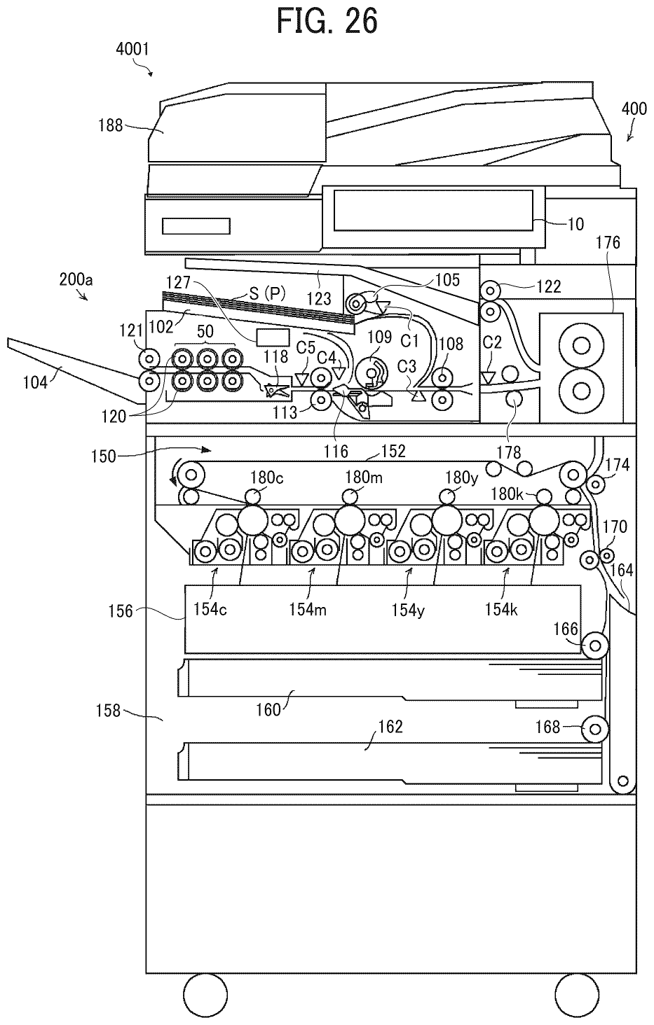

FIG. 26 is a diagram illustrating an overall configuration of an image forming system including the sheet laminator according to the present disclosure and an image forming apparatus according to an embodiment of the present disclosure, as another embodiment of the present disclosure.

In an image forming system 4001 illustrated in FIG. 26, an image forming apparatus 400 is basically the same as the image forming apparatus 300 illustrated in FIG. 25. However, different from the image forming apparatus 300, the image forming apparatus 400 includes a second sheet ejection device 122 and a sheet ejection tray 123.

When the sheet laminating operation is not performed, the image forming apparatus 400 may form an image on the inner sheet P fed from the second sheet tray 162, and then eject the inner sheet P having the image by the second sheet ejection device 122 including a pair of sheet ejection rollers to the sheet ejection tray 123. Accordingly, when the sheet laminating operation is not performed, the image forming apparatus 400 does not need to decrease the output speed of image formation. For this reason, the image forming apparatus 400 can maintain the image formation productivity.

The image forming apparatus 400 may include the sheet laminator 200a detachably attached to the in-body sheet discharging section. In other words, when the sheet laminating operation is not performed, the sheet laminator 200a may be detached from the image forming apparatus 400.

In addition, the sheet laminator 200a thus detached from the image forming apparatus 400 may include the sheet tray 103 to stack the inner sheets P and the pickup roller 106 to feed the inner sheet P from the sheet tray 103, so that the sheet laminator 200a can be used as a single unit such as the sheet laminator 200 illustrated in FIG. 24.

The image forming system 3001 illustrated in FIG. 25 and the image forming system 4001 illustrated in FIG. 26 may include the sheet processing apparatus 100 in an in-body sheet discharging section instead of including the sheet laminator 200a. The image forming system 4001 illustrated in FIG. 26 may include the sheet processing apparatus 100 detachably attachable to the image forming system 4001.

Each of the image forming system 3001 illustrated in FIG. 25 and the image forming system 4001 illustrated in FIG. 26 may include a large-capacity sheet ejection device (stacker), a post-processing apparatus such as a binder unit, or both.

In a case where the lamination sheet S that is stacked on the first sheet tray 160 included in the image forming apparatus 300 illustrated in FIG. 25 or the image forming apparatus 400 illustrated in FIG. 26 passes through the fixing device 176, the lamination sheet S is not bonded at the fixing temperature but is bonded by application of heat higher than the fixing temperature.

Although the image forming apparatus 300 illustrated in FIG. 25 and the image forming apparatus 400 illustrated in FIG. 26 employ electrophotography for image formation on the inner sheet P in the description above, the image formation method is not limited to the above-described configuration. For example, inkjet, stencil printing, or other known printing method may be employed to the image forming apparatus 300 and the image forming apparatus 400.

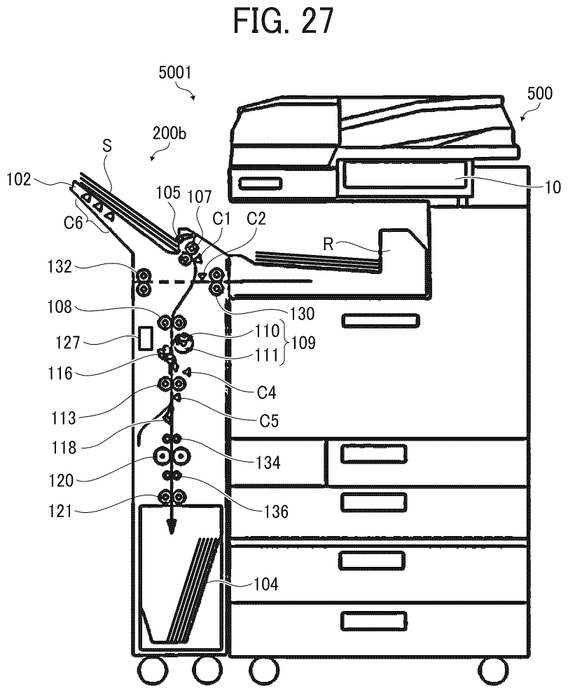

FIG. 27 is a diagram illustrating an image forming system according to yet another embodiment of the present disclosure, including an image forming apparatus and a sheet laminator according to the present disclosure on the outside of the image forming apparatus.

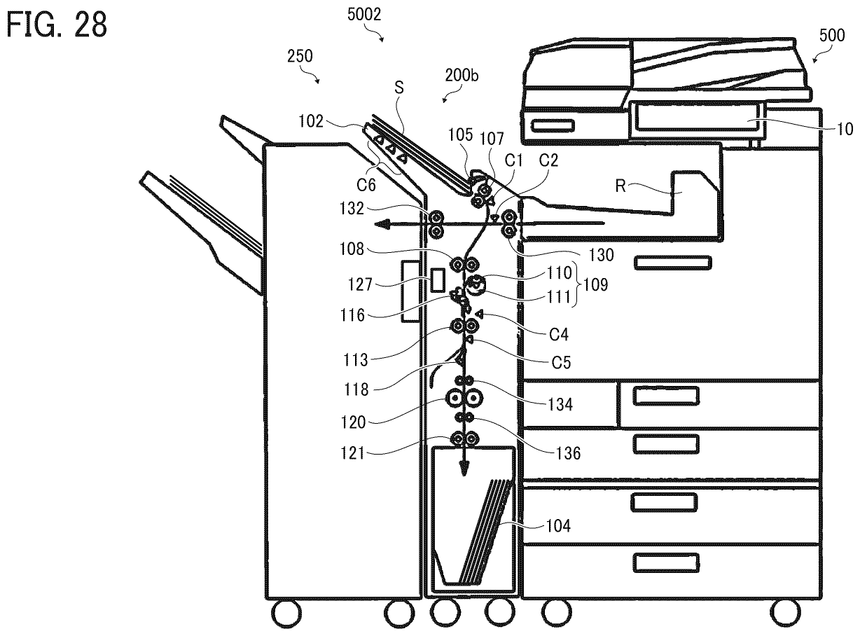

FIG. 28 is a diagram illustrating an image forming system according to yet another embodiment of the present disclosure, including an image forming apparatus and a sheet laminator according to the present disclosure on the outside of the image forming apparatus.

In FIGS. 27 and 28, elements identical to the elements of the image forming system 3001 illustrated in FIG. 25 and the elements of the image forming system 4001 illustrated in FIG. 26 are given identical reference numerals, and the descriptions these elements are omitted.

As illustrated in FIG. 27, an image forming system 5001 is basically same as the image forming system 3001 illustrated in FIG. 25 and the image forming system 4001 illustrated in FIG. 26. However, different from the image forming systems 3001 and 4001, the image forming system 5001 illustrated in FIG. 27 includes a sheet laminator 200b on the outside of an image forming apparatus 500.

The sheet laminator 200b includes the sheet tray 102 on which the lamination sheets S are stacked and has the configuration in which an inner sheet P can be fed from the image forming apparatus 500 via a relay conveyance device R. Due to such a configuration, the image forming system 5001 can automatically perform any image forming operation on an inner sheet P with a copier or a printer (i.e., the image forming apparatus 500), a sheet separating operation on a lamination sheet S, a sheet inserting operation on an inner sheet P having an image into the separated lamination sheet S, and a sheet laminating operation on the lamination sheet S in which the inner sheet P is inserted.

The image forming system 5002 illustrated in FIG. 28 has a configuration in which another post-processing apparatus 250 is disposed further downstream from the sheet laminator 200b in the sheet conveyance direction of the lamination sheet S. This post-processing apparatus 250 includes, for example, a large-capacity sheet ejection device (stacker), a post-processing apparatus such as a binder, or both. According to the request of a user, the job performing the sheet laminating operation and the job not performing the sheet laminating operation can be performed in parallel, which can enhance the working efficiency.

FIG. 29 is a block diagram illustrating a hardware configuration of a control block of the sheet laminator 200 to control the operation performed in the sheet laminator 200.

As illustrated in FIG. 29, the sheet laminator 200 includes a central processing unit (CPU) 901, a random access memory (RAM) 902, a read only memory (ROM) 903, a hard disk drive (HDD) 904, and an interface (I/F) 905. The CPU 901, the RAM 902, the ROM 903, the HDD 904, and the I/F 905 are coupled to each other via a common bus 906.

The CPU 901 is an arithmetic unit and controls the overall operations of the sheet laminator 200.

The RAM 902 is a volatile storage medium that allows data to be read and written at high speed. The CPU 901 uses the RAM 902 as a work area for data processing.

The ROM 903 is a read-only non-volatile storage medium that stores programs such as firmware.

The HDD 904 is a non-volatile storage medium that allows data to be read and written and has a relatively large storage capacity. The HDD 904 stores, e.g., an operating system (OS), various control programs, and application programs.

The sheet laminator 200 processes, by an arithmetic function of the CPU 901, e.g., a control program stored in the ROM 903 and an information processing program (or application program) loaded into the RAM 902. Such processing configures a software controller including various functional modules of the sheet laminator 200. The software controller thus configured cooperates with hardware resources of the sheet laminator 200 to construct functional blocks to implement functions of the sheet laminator 200. In other words, the CPU 901, the RAM 902, the ROM 903, the HDD 904, and the I/F 905 implement a controller 127 to control the operation of the sheet laminator 200.

The I/F 905 is an interface that connects a pickup roller motor 105a, a pickup roller motor 106a, a conveyance roller pair motor 107a, the entrance roller pair motor 108a, the exit roller pair motor 113a, an ejection roller pair motor 121a, the winding roller motor 109a, the sheet gripper motor 110a, the separation member motor 36 (46), a branching member motor 118a, a thermal fixing roller motor 129a, and a heater 54, to the common bus 906. Further, the I/F 905 is an interface that connects the size detection sensors C6 and C7, the sheet conveyance sensors C1, C2, and C3, the abnormal condition detection sensor C4, a first thermostat 58a, a second thermostat 58b, a first thermistor 56a, a second thermistor 56b, a third thermistor 56c, a fourth thermistor 56d, and the control panel 10, to the common bus 906.

The controller 127 controls the operations of the pickup roller motors 105a and 106a, the conveyance roller pair motor 107a, the entrance roller pair motor 108a, the exit roller pair motor 113a, the ejection roller pair motor 121a, the winding roller motor 109a, the sheet gripper motor 110a, the separation member motor 36 (46), the branching member motor 118a, the thermal fixing roller motor 129a, and the heater 54, via the I/F 905. Further, the controller 127 acquires detection results of the size detection sensors C6 and C7, the sheet conveyance sensors C1, C2, C3, and C5, the abnormal condition detection sensor C4, the first thermostat 58a, the second thermostat 58c, the first thermistor 56a, the second thermistor 56b, the third thermistor 56c, and the fourth thermistor 56d via the I/F 905.

The winding roller motor 109a is a driver to drive the winding roller 109 in the forward and reverse directions. The sheet gripper motor 110a is a driver to rotate the sheet gripper 110. The separation member motor 36 (46) is a driver to move the separation members 116 in the width direction of the lamination sheet S. The branching member motor 118a is a driver to switch the position of the branching member 118.

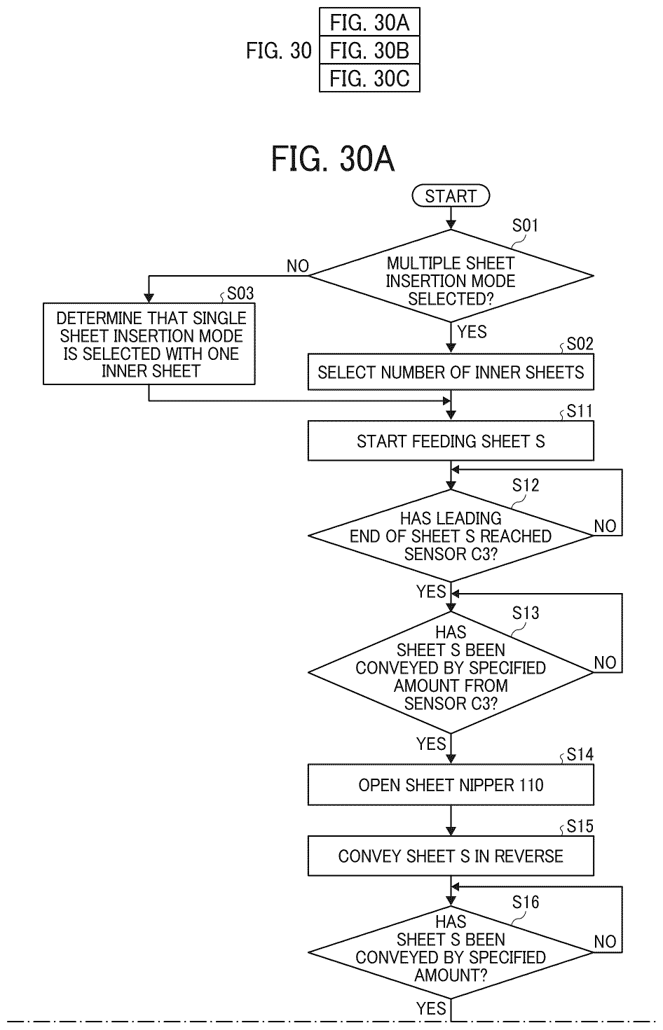

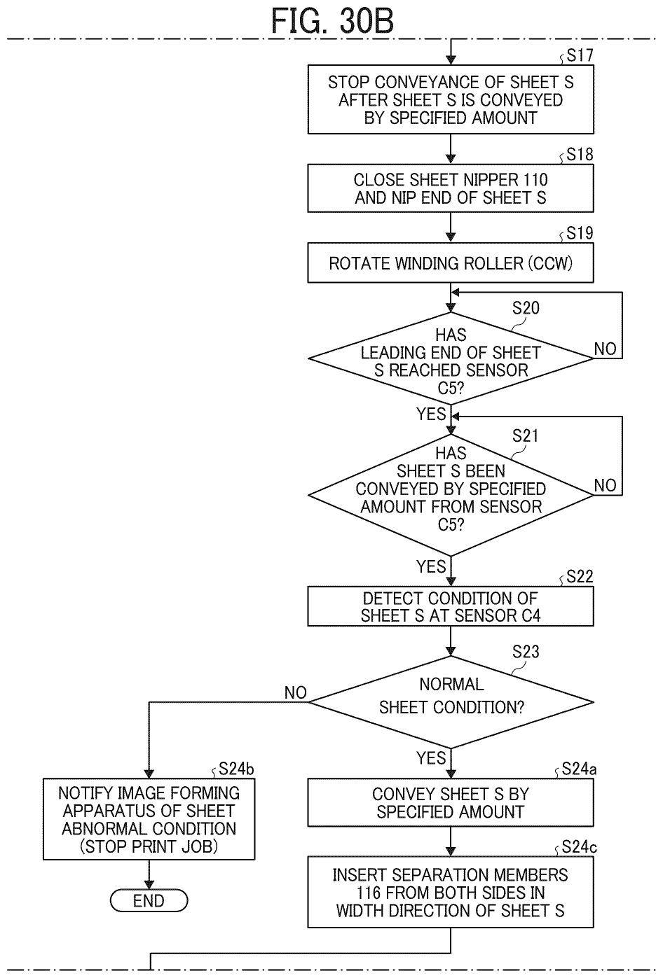

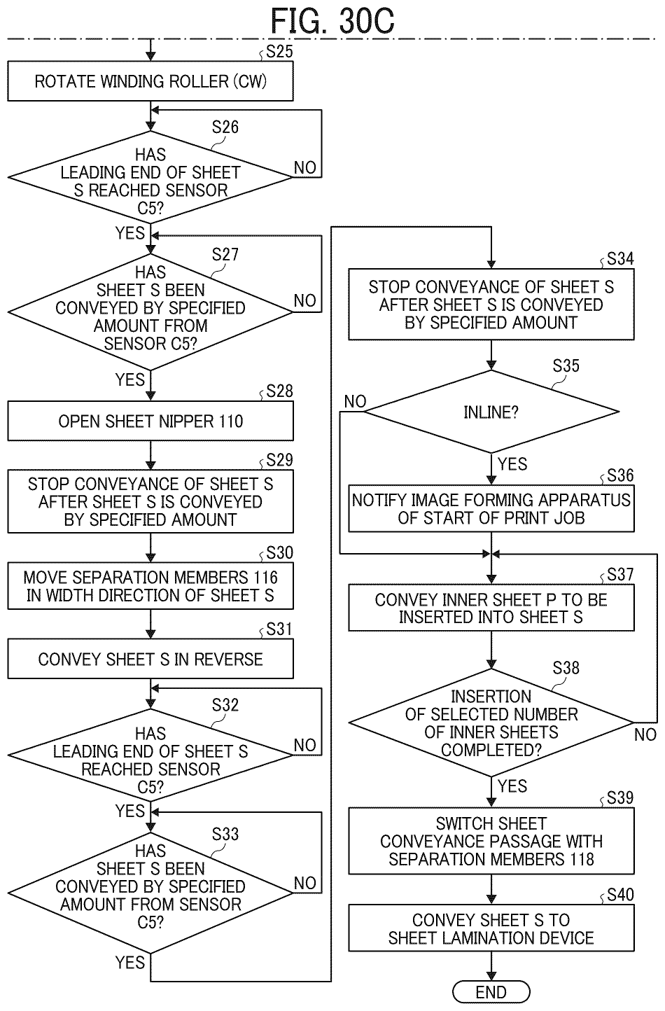

FIG. 30 including FIGS. 30A, 30B, and 30C is a flowchart of a series of operations performed by the image forming system 3001 illustrated in FIG. 25, from feeding a lamination sheet S, inserting an inner sheet P, and completing lamination of the lamination sheet S with the inner sheet P being inserted.

A description is given of the series of operations, with reference to the reference numerals indicated in the flowchart of FIG. 30 including FIGS. 30A, 30B, and 30C.

In the following description, only the sheet laminating operation in the image forming system 3001 illustrated in FIG. 25 is described. However, the sheet laminating operations in the image forming system 4001 illustrated in FIG. 26, the image forming system 5001 illustrated in FIG. 27, and the image forming system 5002 illustrated in FIG. 28 are similar to the image forming system 3001 illustrated in FIG. 25, and thus the detailed description is omitted.

First, in step S01, the image forming system 3001 determines whether a user has selected the multiple sheet insertion mode. When the user has selected the multiple sheet insertion mode (YES in step S01), the image forming system 3001 requests the user inputting the number of inner sheets in step S02. The number of inner sheets can be set by the user with, for example, the control panel 10.

On the other hand, when the user has not selected the multiple sheet insertion mode (NO in step S01), the image forming system 3001 determines whether the user has selected the single sheet insertion mode with one inner sheet in step S03.

Subsequent to step S02 or step S03, the controller 127 of the sheet laminator 200a starts feeding a lamination sheet S (see FIG. 1), in step S11. Then, in step S12, the controller 127 of the sheet laminator 200a determines whether the leading end of the lamination sheet S has reached the sheet conveyance sensor C3 (see FIG. 2). When the leading end of the lamination sheet S has not reached the sheet conveyance sensor C3 (NO in step S12), step S12 is repeated until the lamination sheet S reaches the sheet conveyance sensor C3. On the other hand, when the leading end of the lamination sheet S has reached the sheet conveyance sensor C3 (YES in step S12), the process proceeds to step S13. In step S13, the controller 127 of the sheet laminator 200a determines whether the lamination sheet S has been conveyed by the specified amount from the sheet conveyance sensor C3, and temporarily stops the conveyance (see FIG. 3). When the lamination sheet S has not been conveyed by the specified amount from the sheet conveyance sensor C3 (NO in step S13), step S13 is repeated until the lamination sheet S is conveyed by the specified amount from the sheet conveyance sensor C3. On the other hand, when the lamination sheet S has been conveyed by the specified amount from the sheet conveyance sensor C3 (YES in step S13), the controller 127 of the sheet laminator 200a causes the sheet gripper motor 110a to open the sheet gripper 110 in step S14, and conveys the lamination sheet S in the reverse conveyance direction (i.e., the direction indicated by arrow B in FIG. 4) in step S15 (see FIG. 4).

Then, the controller 127 of the sheet laminator 200a determines whether the lamination sheet S has been conveyed by the specified amount in step S16. When the lamination sheet S has not been conveyed by the specified amount (NO in step S16), step S16 is repeated until the lamination sheet S is conveyed by the specified amount. On the other hand, when the lamination sheet S has been conveyed by the specified amount (YES in step S16), the controller 127 of the sheet laminator 200a temporarily stops the conveyance after the lamination sheet S is conveyed by the specified amount in step S17. Then, in step S18, the controller 127 of the sheet laminator 200a causes the sheet gripper motor 110a to close the sheet gripper 110 to nip the end of the lamination sheet S (see FIG. 5).

Then, in step S19, the controller 127 of the sheet laminator 200a causes the winding roller motor 109a to rotate the winding roller 109 in the counterclockwise direction, so that the lamination sheet S is would around the winding roller 109 (see FIG. 6). In step S20, the controller 127 of the sheet laminator 200a determines whether the leading end of the lamination sheet S has reached at the sheet conveyance sensor C5. When the leading end of the lamination sheet S has not reached the sheet conveyance sensor C5 (NO in step S20), step S20 is repeated until the leading end of the lamination sheet S reaches the sheet conveyance sensor C5. By contrast, when the leading end of the lamination sheet S has reached the sheet conveyance sensor C5 (YES in step S20), the sheet laminator 200a then executes the operation of step S21. In step S21, the controller 127 of the sheet laminator 200a determines whether the lamination sheet S has been conveyed by the specified amount from the sheet conveyance sensor C5. When the lamination sheet S has not been conveyed by the specified amount from the sheet conveyance sensor C5 (NO in step S21), step S21 is repeated until the lamination sheet S is conveyed by the specified amount from the sheet conveyance sensor C5. By contrast, when the lamination sheet S has been conveyed by the specified amount from the sheet conveyance sensor C5 (YES in step S21), the controller 127 of the sheet laminator 200a detects the condition of the lamination sheet S with the abnormal condition detection sensor C4 in step S22.

The abnormal condition detection sensor C4 is an abnormal condition detector that detects whether the dimension of the space g created between the two sheets of the lamination sheet S (the amount of bending of one of the two sheets) exceeds the predetermined threshold. In step S23, the controller 127 of the sheet laminator 200a determines whether the lamination sheet S is in a normal condition, in other words, the size of the space g is equal to or greater than the given threshold, from the detection result of the abnormal condition detection sensor C4. When the sheet laminator 200a determines that the lamination sheet S is in a normal condition (i.e., the size of the space g is equal to or greater than the given threshold) from the detection result of the abnormal condition detection sensor C4 (YES in step S23), the controller 127 of the sheet laminator 200a then executes the operation of step S24a.

On the other hand, when the controller 127 of the sheet laminator 200a determines that the lamination sheet S is in an abnormal condition (i.e., the size of the space g is smaller than the given threshold) from the detection result of the abnormal condition detection sensor C4 (NO in step S23), the controller 127 of the sheet laminator 200a notifies the user of the abnormal condition and stops the sheet processing operation in step S24b. Then, the process of the flowchart ends.

In step S24a, the controller 127 of the sheet laminator 200a conveys the lamination sheet S by the specified amount in a direction opposite to the sheet winding direction (i.e., the direction indicated by arrow A in FIG. 2), so that the bonding portion “r” of the lamination sheet S is located downstream from the nip region of the exit roller pair 113. Accordingly, the space g created between the two sheets of the lamination sheet S can be formed at a position corresponding to the insertion position of the separation members 116.

After step S24a, the sheet laminator 200a executes the operation of step S24c. In step S24c, the controller 127 of the sheet laminator 200a causes the separation member motor 36 to insert the separation members 116 from both sides of the lamination sheet S in the width direction of the lamination sheet S into the space g created between the two sheets of the lamination sheet S (see FIGS. 7 and 20). Then, in step S25, the controller 127 of the sheet laminator 200a causes the winding roller motor 109a to rotate the winding roller 109 in the clockwise direction with the separation members 116 inserted from both sides of the lamination sheet S, and convey the lamination sheet S in the forward conveyance direction (i.e., the direction indicated by arrow A in FIG. 2).

Then, in step S26, the controller 127 of the sheet laminator 200a determines whether the leading end of the lamination sheet S has reached the sheet conveyance sensor C5. When the leading end of the lamination sheet S has not reached the sheet conveyance sensor C5 (NO in step S26), step S26 is repeated until the leading end of the lamination sheet S reaches the sheet conveyance sensor C5. By contrast, when the leading end of lamination sheet S has reached the sheet conveyance sensor C5 (YES in step S26), the sheet laminator 200a executes the operation of step S27. In step S27, the sheet laminator 200a determines whether the lamination sheet S has been conveyed by the specified amount from the sheet conveyance sensor C5. When the lamination sheet S has not been conveyed by the specified amount from the sheet conveyance sensor C5 (NO in step S27), step S27 is repeated until the lamination sheet S is conveyed by the specified amount from the sheet conveyance sensor C5. By contrast, when the lamination sheet S has been conveyed by the specified amount from the sheet conveyance sensor C5 (YES in step S27), the sheet laminator 200a the sheet gripper motor 110a to open the sheet gripper 110 in step S28.

In step S29, the controller 127 of the sheet laminator 200a conveys the lamination sheet S by the specified amount, then temporarily stops the conveyance of the lamination sheet S. Then, in step S30, the controller 127 of the sheet laminator 200a causes the separation member motor 36 to further move the separation members 116 in the width direction of the lamination sheet S (see FIGS. 8 and 22). As a result, the trailing ends of the two sheets of the lamination sheet S are separated into the upper and lower sheets.

In step S31, the sheet laminator 200a conveys the lamination sheet S in the reverse conveyance direction (i.e., the direction indicated by arrow B in FIG. 9). Then, in step S32, the controller 127 of the sheet laminator 200a determines whether the leading end of the lamination sheet S in the forward conveyance direction has reached the sheet conveyance sensor C5. When the leading end of the lamination sheet S has not reached the sheet conveyance sensor C5 (NO in step S32), step S32 is repeated until the leading end of the lamination sheet S reaches the sheet conveyance sensor C5. By contrast, when the leading end of lamination sheet S has reached the sheet conveyance sensor C5 (YES in step S32), the sheet laminator 200a then executes the operation of step S33. In step S33, the controller 127 of the sheet laminator 200a determines whether the lamination sheet S has been conveyed by a specified amount from the sheet conveyance sensor C5. When the lamination sheet S has not been conveyed by the specified amount from the sheet conveyance sensor C5 (NO in step S33), step S33 is repeated until the lamination sheet S is conveyed by the specified amount from the sheet conveyance sensor C5. By contrast, when the lamination sheet S has been conveyed by the specified amount from the sheet conveyance sensor C5 (YES in step S33), the sheet laminator 200a temporarily stops the conveyance of the lamination sheet S in step S34 (see FIG. 9). As a result, the separation of the lamination sheet S is completed. In other words, one sheet (first sheet S1) of the two sheets of the lamination sheet S is guided to the first branched conveyance passage K1, and the other sheet (second sheet S2) is guided to the second branched conveyance passage K2. The configuration and operation of each of the branched conveyance passages K1 and K2 according to the present embodiment are described in further detail below, with reference to FIGS. 31A to 34B.

Subsequently, in step S35, the controller 127 of the sheet laminator 200a determines whether to perform the image forming operation (with an inline image forming apparatus) on the inner sheet P to be inserted into the lamination sheet S. When the image forming operation is performed with an inline image forming apparatus (YES in step S35), the sheet laminator 200a sends a signal to notify the inline image forming apparatus, for example, the image forming apparatus 300 (or the image forming apparatus 400 or the image forming apparatus 500) to start the print job (printing operation) to form an image on the inner sheet P in step S36. Then, the sheet laminator 200a executes the operation of step S37.

By contrast, when the image forming operation is not performed with an inline image forming apparatus (NO in step S35), the sheet laminator 200a then executes the operation of step S37.

In step S37, the sheet laminator 200a conveys the inner sheet P in the forward conveyance direction (i.e., the direction indicated by arrow A in FIG. 10), so as to insert the inner sheet P into the opening of the lamination sheet S. In step S37, when the single sheet insertion mode is selected, the sheet laminator 200a performs the operations illustrated in FIGS. 10 to 12. On the other hand, when the multiple sheet insertion mode is selected, the sheet laminator 200a performs the operations illustrated in FIGS. 13 to 16.

In step S38, the controller 127 of the sheet laminator 200a determines whether the selected number of inner sheets P is completely inserted into the lamination sheet S. When the selected number of inner sheets P are not inserted into the lamination sheet S (NO in step S38), step S38 is repeated until the selected number of inner sheets P are inserted into the lamination sheet S. On the other hand, when the selected number of inner sheets P are inserted into the lamination sheet S (YES in step S38), the sheet laminator 200a then executes the operation of step S39.

Then, in step S39, the controller 127 of the sheet laminator 200a causes the branching member motor 118a to rotate the branching member 118 to switch (change) the sheet conveyance passage of the lamination sheet S with the separation members 116. In step S40, the sheet laminator 200a conveys the lamination sheet S sandwiching the inner sheet P between the two sheets of the lamination sheet S to the sheet lamination device 50 (thermal fixer). By application of heat and pressure to the lamination sheet S, the sheet laminating operation completes (see FIG. 17).

When the image forming operation is performed with an inline image forming apparatus (YES in step S35), the sheet laminator 200a sends a signal to notify the inline image forming apparatus, for example, the image forming apparatus 300 (or the image forming apparatus 400 or the image forming apparatus 500) to start the print job, then performs the printing operation on the inner sheet P and conveys the inner sheet P. In this case, the sheet processing apparatus 100 waits until the printed inner sheet P is conveyed and reaches the sheet conveyance sensor C1. The sheet laminator 200a may send the image forming apparatus 300 (or the image forming apparatus 400 or the image forming apparatus 500) the signal to start the print job in advance based on a time to convey the printed inner sheet P, for example, after the separation members 116 complete the operations illustrated in FIG. 7. Due to such a configuration, the productivity can be enhanced.

A detailed description is now given of the configuration and functions of a sheet processing apparatus 100 according to an embodiment of the present disclosure, with reference to FIGS. 31A to 34B.

FIGS. 31A and 31B are enlarged views of an area including a branched conveyance passage.

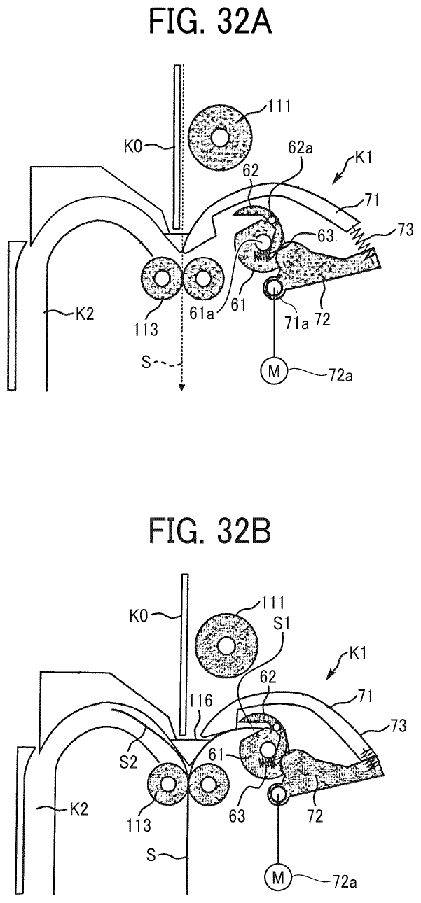

FIGS. 32A and 32B are diagrams illustrating operations of a take-up roller (winder) disposed in the branched conveyance passage of FIGS. 31A and 31B.

FIGS. 33A and 33B are diagrams illustrating operations of the take-up roller, subsequent from the operations of FIGS. 32A and 32B.

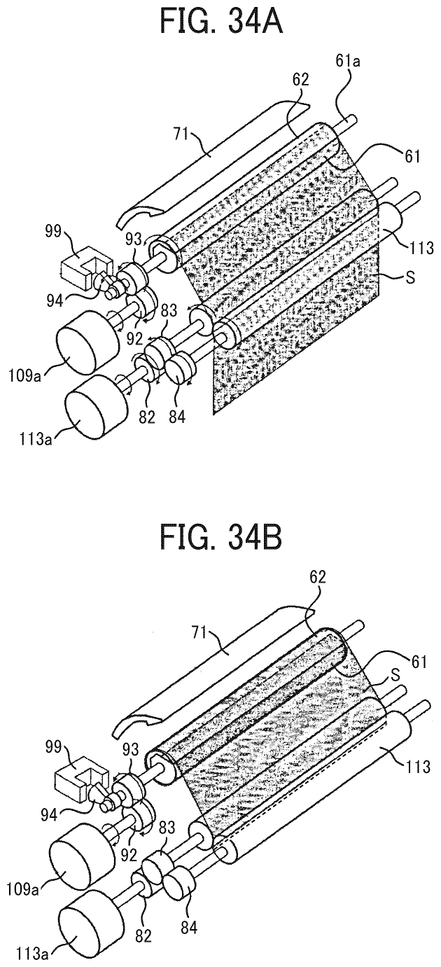

FIGS. 34A and 34B are perspective views, each illustrating the operation of a driving mechanism of the take-up roller.

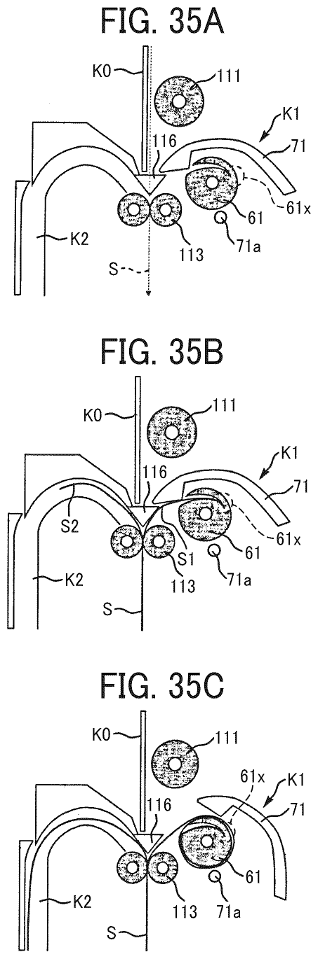

In FIGS. 31A to 33B (and FIGS. 35A, 35B, and 35C described below), the horizontal direction is rotated by 90 degrees and illustrated as the vertical direction for easy understanding.

As described above, the sheet processing apparatus 100 according to the present embodiment includes the sheet separation device 1 that separates the non-bonding portion of the lamination sheet S (two-ply sheet) in which two sheets, which are the first sheet P1 and the second sheet P2, are overlapped and bonded together at the bonding portion “r” of the lamination sheet S. The sheet separation device 1 conveys (performs branched conveyance on) one sheet (first sheet S1) of the two sheets peeled (separated) from each other of the lamination sheet S to the first branched conveyance passage K1 and the other sheet (second sheet S2) of the two sheets to the second branched conveyance passage K2 that is a branched conveyance passage branched in a direction different from the first branched conveyance passage K1. Specifically, as described above with reference to FIGS. 7 to 9, the separation members 116 are inserted between the first sheet S1 and the second sheet S2 to separate the first sheet S1 and the second sheet S2 to a small extent, and eventually the first sheet S1 and the second sheet S2 are conveyed to the first branched conveyance passage K1 and the second branched conveyance passage K2, respectively, to be largely separated from each other.

Referring to the drawings including FIGS. 31A and 31B, the first branched conveyance passage K1 and the second branched conveyance passage K2 are disposed on the opposite sides across a main conveyance passage K0 that functions as a pre-separation conveyance passage or a conveyance passage in which the lamination sheet S is conveyed before the sheet separating operation. Specifically, the first branched conveyance passage K1 is branched to the upper side of the main conveyance passage K0 (to the right side in FIGS. 31A to 33B) and the second branched conveyance passage K2 is branched to the lower side of the main conveyance passage K0 (to the left side in FIGS. 31A to 33B).

Further, the two branched conveyance passages, which are the first branched conveyance passage K1 and the second branched conveyance passage K2, according to the present embodiment correspond to the branched conveyance passages illustrated in FIG. 23A among FIGS. 23A, 23B, and 23C.

Further, the exit roller pair 113 is disposed downstream from the portion where the first branched conveyance passage K1 and the second branched conveyance passage K2 meet, in the forward conveyance direction. Further, the exit roller pair 113 functions as a conveyance roller pair to convey the two sheets (the first sheet S1 and the second sheet S2) separated from each other toward the first branched conveyance passage K1 and the second branched conveyance passage K2, respectively. Specifically, the exit roller pair 113 rotates in the reverse direction, so that the lamination sheet S with the first sheet S1 and the second sheet S2 separated from each other by the separation members 116 can be conveyed in the opposite conveyance direction. As a result, the first sheet S1 is conveyed to the first branched conveyance passage K1 and the second sheet S2 is conveyed to the second branched conveyance passage K2.

The first sheet S1 and the second sheet S2 of the lamination sheet S (two-ply sheet) in the present embodiment are bonded with the adhesive (used to bond the first sheet S1 and the second sheet S2 in the sheet laminating operation). The glue is put only on the inner face of the first sheet S1, in other words, the face of the first sheet S1 opposite to the second sheet S2).

The sheet processing apparatus 100 according to the present embodiment further includes a take-up roller 61 functioning as a winder to take up and grip a sheet (the first sheet S1) conveyed to the branched conveyance passage (the first branched conveyance passage K1), to at least one of the first branched conveyance passage K1 or the second branched conveyance passage K2 (only to the first branched conveyance passage K1 in the present embodiment) while gripping the leading end of the sheet in the conveyance direction of the sheet. The leading end of the sheet indicates the leading end of the sheet in the opposite conveyance direction and the portion enclosed by the broken line in FIG. 32B.

The take-up roller 61 as a winder is a roller that is rotatable around the rotary shaft 61a in the forward and reverse directions and is supported by the housing of the sheet processing apparatus 100.

The sheet separation device 1 further includes a chuck 62 as a gripper that is mounted on the take-up roller 61.

The chuck 62 functions as a gripper movable between a gripping position and a standby position. The gripping position is a position at which the chuck 62 can grip the leading end in the conveyance direction of the first sheet S1 conveyed to the first branched conveyance passage K1, as illustrated in FIGS. 31A, 33A and 33B. The standby position is a position at which the chuck 62 is separated from the gripping position, as illustrated in FIGS. 31B, 32A and 32B.

Specifically, as illustrated in the drawings such as FIGS. 31A and 31B, the chuck 62 as a gripper is supported by the take-up roller 61 and is rotatable about a support shaft 62a. The sheet separation device 1 further includes a compression spring 63. One end of the compression spring 63 is coupled to one end of the chuck 62, and the other end of the compression spring 63 is coupled to the take-up roller 61. With such a configuration, the chuck 62 is located at the gripping position (the position illustrated in FIGS. 31A, 33A and 33B) by the biasing force of the compression spring 63 when the external force is not applied (in other words, in the closed state). On the other hand, the chuck 62 is located at the standby position (the position illustrated in FIGS. 31B, 32A and 32B) against the biasing force of the compression spring 63 when the external force of a pressure lever 72 described below is applied.

In addition, the sheet separation device 1 further includes a rotary guide plate 71 as a guide disposed in the first branched conveyance passage K1 in which the take-up roller 61 (as a winder) is disposed. The rotary guide plate 71 is disposed to guide the first sheet S1 to be conveyed to the first branched conveyance passage K1, toward the take-up roller 61. The rotary guide plate 71 (as a guide) is curved in a direction along the outer circumferential face of the take-up roller 61. Further, the rotary guide plate 71 is supported by the housing of the sheet processing apparatus 100 to be rotatable about a rotary shaft 71a. The rotary guide plate 71 disposed as described above and the take-up roller 61 in a rotary shape define the first branched conveyance passage K1 as described above with reference to FIG. 23A.

The rotary guide plate 71 (as a guide) is rotatable between a guiding position and a retracted position. The guiding position is a position at which the rotary guide plate 71 guides the first sheet S1 to be conveyed to the first branched conveyance passage K1, toward the take-up roller 61, as illustrated in FIGS. 31B, 32A and 32B. The retracted position is a position at which the rotary guide plate 71 does not bother a winding operation of the first sheet S1 by the take-up roller 61, as illustrated in FIGS. 31A, 33A and 33B.

Specifically, the rotary guide plate 71 (as a guide) is rotatable about the rotary shaft 71a together with the pressure lever 72.

The pressure lever 72 is supported by the housing of the sheet processing apparatus 100 to be rotatable about the rotary shaft 71a. The pressure lever 72 is rotated between a pressing position and a pressure releasing position by the control of rotation (the control of a pressure lever motor 72a, as illustrated in FIG. 29, that drives the rotary shaft 71a) of the rotary shaft 71a by the controller 127. The pressing position is a position at which the pressure lever 72 presses (pushes) the chuck 62, as illustrated in FIGS. 31B, 32A and 32B. The pressure releasing position is a position at which the pressure applied by the chuck 62 is released, as illustrated in FIGS. 31A, 33A and 33B.

One end of the pressure lever 72 is coupled to one end of a tension spring 73, and the other end of the tension spring 73 is coupled to one end of the rotary guide plate 71. With such a configuration, the rotary guide plate 71 is rotated from the guiding position to the retracted position (or from the retracted position to the guiding position) as described above, in conjunction with the rotation of the pressure lever 72 from the pressing position to the pressure release position (or from the pressure release position to the pressing position) as described above.

Further, the chuck 62 (as a gripper) moves from the standby position to the gripping position (or moves from the gripping position to the standby position) in conjunction with the rotation of the rotary guide plate 71 (as a guide) from the guiding position to the retracted position (or from the retracted position to the guiding position).

In the present embodiment, the second branched conveyance passage K2 is different from the first branched conveyance passage K1. The second branched conveyance passage K2 includes two guide plates that are unrotatably fixed at respective positions opposite to each other.

With reference to FIGS. 32A, 32B, 33A, and 33B, a detailed description is given of the sheet separating operation (the branched conveyance to convey the first sheet S1 and the second sheet S2 of the lamination sheet S to the first branched conveyance passage K1 and the second branched conveyance passage K2) described above with reference to FIG. 9.

First, as illustrated in FIG. 32A, the lamination sheet S subjected to the process described above with reference to FIGS. 1 to 8 is conveyed in the main conveyance passage K0 in the direction indicated by arrow with a broken line (the forward conveyance direction), and is further conveyed in the forward conveyance direction by the exit roller pair 113.

At this time, the rotary guide plate 71 is located at the guiding position, and the chuck 62 is located at the standby position.

At the guiding position illustrated in FIG. 32A, the rotary guide plate 71 (as a guide) can guide the lamination sheet S in the main conveyance passage K0 (conveyance passage) to be conveyed in the forward conveyance direction. As a result, the lamination sheet S to be conveyed in the forward conveyance direction is smoothly conveyed toward the nip region of the exit roller pair 113.

Then, as described above with reference to FIG. 9, the first sheet S1 and the second sheet S2 of the lamination sheet S are separately conveyed to the first branched conveyance passage K1 and the second branched conveyance passage K2, respectively, while the first sheet S1 and the second sheet S2 of the lamination sheet S are separated from each other by the separation members 116.

At this time, as illustrated in FIG. 32B, the rotary guide plate 71 is located at the guiding position while the rotation of the rotary guide plate 71 is stopped, and the chuck 62 is located at the standby position (in the open state). Then, the leading end of the first sheet S1 (the portion enclosed by the broken line in FIG. 32B) is guided to a portion between the chuck 62 and the take-up roller 61 in the open state by the rotary guide plate 71 located at the guiding position.

At this time, the take-up roller 61 is in the state where the rotation is stopped.

In order to reliably guide the first sheet S1 as described above, the inner circumferential face of the leading end of the rotary guide plate 71 is projected toward the take-up roller 61 as illustrated in FIG. 32B.

Then, as illustrated in FIG. 33A, the rotary guide plate 71 rotates about the rotary shaft 71a together with the pressure lever 72 by the control of the pressure lever motor 72a by the controller 127 in the clockwise direction in FIG. 33A. As a result, the rotary guide plate 71 moves from the guiding position to the retracted position, and the pressure lever 72 moves from the pressing position to the pressure release position. Then, when the pressure applied by the pressure lever 72 is released, the chuck 62 (as a gripper) moves (rotates) from the standby position to the gripping position, and the leading end of the first sheet S1 is gripped (nipped) between the chuck 62 and the take-up roller 61 in the open state.

Then, as illustrated in FIG. 33B, the take-up roller 61 is rotated in the clockwise direction in FIG. 33B about the rotary shaft 61a by the control of the winding roller motor 109a (see FIGS. 34A and 34B) by the controller 127. By so doing, the first sheet S1 is wound around the take-up roller 61.

Due to such a configuration, the first sheet S1 is less likely to be damaged by receiving a failure (conveyance failure) in which the first sheet S1 is buckled or bent due to an inconvenience in which the adhesive applied on the inner face of the first sheet S1 sticks to or is caught by a member disposed in the first branched conveyance passage K1. In other words, since the inner face (the adhesive attached face) of the first sheet S1 hardly contacts the member in the first branched conveyance passage K1, the first sheet S1 is less likely to be damaged by the conveyance failure.

On the other hand, the second sheet S2 having no adhesive applied to the inner face is separately conveyed along the second branched conveyance passage K2 including a pair of fixed guide plates, as illustrated in FIGS. 32A, 32B, 33A and 33B, when the first sheet S1 described above is separately conveyed.

After completion of the branched conveyance of the first sheet S1 in the first branched conveyance passage K1 by winding the first sheet S1 by the take-up roller 61, the sheet inserting operation described above with reference to FIGS. 10 to 12 (the operation to insert the inner sheet P between the first sheet S1 and the second sheet S2 of the lamination sheet S) is performed. Then, the exit roller pair 113 is rotated in the forward conveyance direction, and the lamination sheet S with the inner sheet P inserted is conveyed to the forward conveyance direction. At this time, the take-up roller 61 is rotated in the counterclockwise direction in FIGS. 33A and 33B. Further, at the optimum timing that does not obstruct the conveyance of the first sheet S1 in the forward conveyance direction in the first branched conveyance passage K1, the pressure lever 72 and the rotary guide plate 71 are rotated in the counterclockwise direction in FIGS. 33A and 33B so that the gripping (nipping) of the leading end of the first sheet S1 by the chuck 62 is released.

As described above, the sheet processing apparatus 100 according to the present embodiment includes the take-up roller 61 in the first branched conveyance passage K1 so that the take-up roller 61 winds the first sheet S1 while gripping (nipping) the leading end of the first sheet S1. Due to such a configuration, the first sheet S1 and the second sheet S2 of the lamination sheet S can be preferably separated from each other.

In other words, when the first sheet S1 and the second sheet S2 of the lamination sheet S are separated from each other, a failure (conveyance failure) in which the first sheet S1 and the second sheet S2 are caught in the first branched conveyance passage K1 and the second branched conveyance passage K2, respectively, is less likely to occur. As a result, the lamination sheet S can be fully separated in a preferable manner, and the inner sheet P can be preferably inserted after the separation of the lamination sheet S.

In the present embodiment, of the first sheet S1 and the second sheet S2 of the lamination sheet S (two-ply sheet), the adhesive is applied only to the inner face of the first sheet S1. For this reason, the take-up roller 61 is disposed only in the first branched conveyance passage K1 in which the first sheet S1 is separately conveyed.

In contrast, in a case where the adhesive is applied only to the inner face of the second sheet S2 or in a case where the conveyance failure is likely to occur when the second sheet S2 is conveyed in the second branched conveyance passage K2, the take-up roller may be disposed only in the second branched conveyance passage K2 in which the second sheet S2 is conveyed.

Further, in a case where the adhesive is applied to the inner face of the first sheet S1 and the inner face of the second sheet S2 or in a case where the conveyance failure is likely to occur to the first sheet S1 and the second sheet S2 in the first branched conveyance passage K1 and the second branched conveyance passage K2, the take-up roller may be disposed in both of the first branched conveyance passage K1 and the second branched conveyance passage K2.

In the present embodiment, when the winding operation of the take-up roller 61 (as a winder) described above with reference to FIG. 33B is performed, the controller 127 controls the sheet conveyance speed of the take-up roller 61 (as a winder) performing the winding operation to be faster than the sheet conveyance speed of the exit roller pair 113 (as a conveyance roller pair).

The phrase “the sheet conveyance speed of the take-up roller 61 (as a winder) performing the winding operation” indicates a speed to convey (wind) the first sheet S1 by the take-up roller 61 (as a winder) alone and is substantially a linear velocity on the outer circumferential face of the take-up roller 61. On the other hand, the phrase “the sheet conveyance speed of the exit roller pair 113 (as a conveyance roller pair)” indicates a speed to convey the first sheet S1 by the exit roller pair 113 (as a conveyance roller pair) alone and is substantially a linear velocity in the nip region of the exit roller pair 113.

Due to such a configuration, when the winding operation of the take-up roller 61 (as a winder) is performed, the first sheet S1 is less likely to have a slack between the take-up roller 61 and the exit roller pair 113 and the winding operation of the take-up roller 61 is preferably performed.

With reference to FIGS. 34A and 34B, the sheet processing apparatus 100 according to the present embodiment includes a photosensor 99 functioning as a detector to detect the end of the winding operation on the first sheet S1 (sheet) by the take-up roller 61 (as a winder).

After the photosensor 99 (as a detector) detects the end of the winding operation, the sheet separation device 1 (the sheet processing apparatus 100) performs the sheet inserting operation to insert the inner sheet P between the first sheet S1 and the second sheet S2 separated from each other while the exit roller pair 113 gripping (nipping) the bonding portion of the lamination sheet S is rotated in the reverse direction (the opposite direction to the rotational direction in the winding operation).

Specifically, the take-up roller 61 is mounted on the rotary shaft 61a so as to rotate with a feeler 94 in phase with the rotary shaft 61a. Further, a torque limiter mounted gear 93 that rotates with the rotary shaft 61a of the take-up roller 61 is mounted on the rotary shaft 61a. A gear 92 mounted on the motor shaft of the winding roller motor 109a is meshed with the torque limiter mounted gear 93. Due to such a configuration, the driving force of the winding roller motor 109a is transmitted to the rotary shaft 61a of the take-up roller 61.

When the drive torque of the take-up roller 61 exceeds a given value by the torque limiter of the torque limiter mounted gear 93, the driving force of the winding roller motor 109a is not transmitted to the take-up roller 61. As a result, the take-up roller 61 stops the rotation.

A photosensor 99 that functions as a detector is attached to the housing of the sheet separation device 1. The rotation of the feeler 94 is detected by the photosensor 99.

Specifically, referring to FIG. 34A, when the winding operation of the first sheet S1 is performed by the take-up roller 61 as described above with reference to FIG. 33B, the signal of the photosensor 99 is repeatedly turned on and off in accordance with the rotation cycle of the take-up roller 61.

Referring to FIG. 34B, when the bonding portion of the lamination sheet S is nipped by the nip region of the exit roller pair 113 (or when the bonding portion and the nip region are separated apart by a given distance) and the exit roller pair 113 stops rotating, the first sheet S1 is pulled between the exit roller pair 113 by the rotation of the take-up roller 61 for a moment. Due to such a configuration, the drive torque of the take-up roller 61 exceeds a the above-described threshold value, and the torque limiter of the torque limiter mounted gear 93 activates to stop the rotation of the take-up roller 61. When the rotation of the take-up roller 61 is stopped as described above, the rotation of the feeler 94 is also stopped. Due to such a configuration, the signal of the photosensor 99 is not changed between ON and OFF, so that the stop of the rotation of the take-up roller 61 (the end of the sheet winding operation) is detected.

In response to such a detection of the end of the sheet winding operation by the photosensor 99, the sheet inserting operation starts performing on the inner sheet P.

As illustrated in FIGS. 34A and 34B, in the present embodiment, the driving force of the exit roller pair motor 113a is transmitted to the exit roller pair 113 via a gear train including gears 82, 83, and 84.

### Modification

FIGS. 35A, 35B, and 35C are diagrams, each illustrating the operation of the take-up roller (as a winder) according to a modification of the above embodiments.

As illustrated in FIGS. 35A, 35B, and 35C, the take-up roller 61 (as a winder) according to the modification of the above embodiments includes a wedge-shaped gripper 61x that can grip the first sheet S1 (sheet) conveyed to the first branched conveyance passage K1 (as a branched conveyance passage) with the leading end of the first sheet S1 in the conveyance direction contacting the take-up roller 61.

As illustrated in FIGS. 35A, 35B, and 35C, the sheet separation device 1 (the sheet processing apparatus 100) according to the modification is different from the sheet separation device 1 (the sheet processing apparatus 100) described with reference to FIGS. 31A to 34B. Specifically, the sheet separation device 1 (the sheet processing apparatus 100) according to the modification does not includes the pressure lever 72 and the tension spring 73, and the take-up roller 61 does not include the chuck 62 and the compression spring 63. The take-up roller 61 according to the modification has a cut (cut gripper) that is cut obliquely inward in a wedge shape in the clockwise direction in FIGS. 35A, 35B and 35C from a part of the outer circumferential face of the take-up roller 61. The leading end of the cut functions as the wedge-shaped gripper 61x.

As illustrated in FIG. 35A, the lamination sheet S is conveyed in the forward conveyance direction to the position of the exit roller pair 113. Then, as illustrated in FIG. 35B, the exit roller pair 113 rotates in the reverse direction to separately convey the first sheet S1 and the second sheet S2 to the first branched conveyance passage K1 and the second branched conveyance passage K2, respectively. At this time, as illustrated in FIG. 35B, the first sheet S1 is guided toward the wedge-shaped gripper 61x (as a cut gripper) of the take-up roller 61 by the rotary guide plate 71 located at the guiding position. Then, when the leading end of the first sheet S1 contacts the wedge-shaped gripper 61x so as to be inserted into the wedge-shaped gripper 61x, the first sheet S1 is gripped (nipped) by the wedge-shaped gripper 61x. In this state, as illustrated in FIG. 35C, the take-up roller 61 is rotated in the clockwise direction, and the first sheet S1 is wound by the take-up roller 61. When the winding operation by the take-up roller 61 is started, the rotary guide plate 71 is rotated from the guiding position to the retracted position.

Except for the unique operation described above, the take-up roller 61, the rotary guide plate 71, and the exit roller pair 113 operate in substantially the same manner as those described above with reference to FIGS. 32A, 32B, 33A and 33B.

As a result, when the take-up roller 61 according to the modification is used, the force of the take-up roller 61 initially gripping the leading end of the sheet is relatively weak, but the above-described configuration can efficiently separate the first sheet S1 and the second sheet S2 of the lamination sheet S. Further, when the take-up roller 61 according to the modification is used, the number of parts of the entire sheet processing apparatus 100 can be reduced, and the sheet processing apparatus 100 can be reduced in cost and size.

As described above, the sheet processing apparatus 100 according to the above-described embodiments includes the sheet separation device 1 that performs the sheet separating operation to separate the non-bonding portion of the lamination sheet S in which two sheets, which are the first sheet S1 and the second sheet S2, are overlapped and bonded together at the bonding portion “r” of the lamination sheet S. Further, the sheet separation device 1 conveys the first sheet S1 of the two sheets separated from each other to the first branched conveyance passage K1 and the second sheet S2 of the two sheets separated from each other to the second branched conveyance passage K2 that extends in the direction opposite to the direction of the first branched conveyance passage K1. Further, at least one of the first branched conveyance passage K1 or the second branched conveyance passage K2, to be more specific, the first branched conveyance passage K1 in the present embodiment includes the take-up roller 61 (as a winder) to take up and grip the first sheet S1 conveyed to the first branched conveyance passage K1 with the leading end of the first sheet S1 in the conveyance direction gripped by the take-up roller 61.

As a result, the above-described configuration efficiently separates the first sheet S1 and the second sheet S2 of the lamination sheet S.

The present disclosure is not limited to the above-described embodiment and variations, and the configuration of the present embodiment can be appropriately modified other than suggested in the above embodiment and variations within a scope of the technological concept of the present disclosure. Further, the number, position, shape, and so forth of components are not limited to those of the present embodiment and variations, and may be the number, position, shape, and so forth that are suitable for implementing the present disclosure.

A description is now given of some aspects of the present disclosure.

### Aspect 1

In Aspect 1, a sheet processing apparatus includes a sheet separation device and a winder. The sheet separation device separates a non-bonding portion of a two-ply sheet having two sheets overlapped and bonded together at a bonding portion, conveys a first sheet of the two sheets separated from each other to a first branched conveyance passage, and conveys a second sheet of the two sheets separated from each other to a second branched conveyance passage. The winder is disposed on at least one conveyance passage of the first branched conveyance passage or the second branched conveyance passage. The winder winds one of the first sheet and the second sheet conveyed, as a sheet to be wound, to the at least one conveyance passage while gripping a leading end of the sheet to be wound in a conveyance direction in which the sheet to be wound is conveyed.

### Aspect 2

In Aspect 2, in the sheet processing apparatus according to Aspect 1, the at least one conveyance passage includes a guide to guide the sheet to be wound that is conveyed in the at least one conveyance passage, toward the winder.

### Aspect 3

In Aspect 3, in the sheet processing apparatus according to Aspect 2, the guide is rotatably disposed between a guiding position at which the sheet to be wound that is conveyed to the at least one conveyance passage is guided toward the winder and a retracted position at which the winder winds the sheet to be wound.

### Aspect 4

In Aspect 4, in the sheet processing apparatus according to any one of Aspect 1 to 3, the winder includes a gripper movable between a gripping position at which the winder grips the leading end of the sheet to be wound that is conveyed to the at least one conveyance passage in the conveyance direction and a standby position at which the winder is separated from the gripping position.

### Aspect 5

In Aspect 5, in the sheet processing apparatus according to Aspect 4, the gripper moves from the standby position to the gripping position in conjunction with a rotation of the guide from the guiding position to the retracted position.

### Aspect 6

In Aspect 6, in the sheet processing apparatus according to any one of Aspects 1 to 5, the winder has a wedge-shaped gripper that grips the sheet to be wound that is conveyed to the at least one conveyance passage, with a leading end of the sheet to be wound in the conveyance direction contacting the winder.

### Aspect 7

In Aspect 7, in the sheet processing apparatus according to any one of Aspects 2 to 6, the first branched conveyance passage and the second branched conveyance passage are disposed on opposite sides across another conveyance passage to which the two-ply sheet is conveyed prior to the sheet separating operation, and the guide guides the two-ply sheet in said another conveyance passage when the guide is at the guiding position.

### Aspect 8

In Aspect 8, in the sheet processing apparatus according to any one of Aspects 2 to 7, the winder includes a take-up roller having an outer circumferential face, and the guide is curved in a direction along the outer circumferential face of the take-up roller.

### Aspect 9

In Aspect 9, the sheet processing apparatus according to any one of Aspects 1 to 8 further includes a conveyance roller pair to convey the two sheets separated from each other to the first branched conveyance passage and the second branched conveyance passage. A first sheet conveyance speed in a winding operation of the winder is faster than a second sheet conveyance speed by the conveyance roller pair.

### Aspect 10

In Aspect 10, the sheet processing apparatus according to any one of Aspects 1 to 9 further includes a detector to detect an end of the sheet winding operation by the winder.

### Aspect 11

In Aspect 11, the sheet processing apparatus according to Aspect 10 further includes a conveyance roller pair to convey the two sheets separated from each other to the first branched conveyance passage and the second branched conveyance passage. The sheet separation device performs a sheet inserting operation to insert an inner sheet between the two sheets separated from each other while the conveyance roller pair gripping the bonded portion is rotated in a direction opposite to the conveyance direction, after the end of the sheet winding operation is detected by the winder.

### Aspect 12

In Aspect 12, the sheet processing apparatus according to any one of Aspects 1 to 9 further includes a sheet lamination device to perform a sheet laminating operation on the two-ply sheet with the inner sheet inserted between the two sheets of the two-ply sheet by the sheet separation device.

### Aspect 13

In Aspect 13, an image forming system includes the sheet processing apparatus according to any one of Aspects 1 to 12, and an image forming apparatus to form an image on an inner sheet to be conveyed to the sheet processing apparatus.

### Aspect 14

In Aspect 14, a sheet processing apparatus includes a main conveyance passage, a first branched conveyance passage, a second branched conveyance passage, a sheet separation device, and a winder. The main conveyance passage conveys a two-ply sheet having two sheets overlapped and bonded together at a bonding portion in a conveyance direction. The first branched conveyance passage is branched from the main conveyance passage in a first direction. The second branched conveyance passage is branched from the main conveyance passage in a second direction different from the first direction. The sheet separation device separates a non-bonding portion of the two-ply sheet, convey a first sheet of the two sheets separated from each other to the first branched conveyance passage, and convey a second sheet of the two sheets separated from each other to the second branched conveyance passage. The winder is disposed on at least one of the first branched conveyance passage or the second branched conveyance passage. The winder includes a gripper to grip a leading end, in one of the first direction or the second direction, of one of the first sheet and the second sheet conveyed to corresponding one of the first branched conveyance passage and the second branched conveyance passage by the sheet separation device, and a roller, to which the gripper is attached, to rotate and wind one of the first sheet and the second sheet, the leading end of which is gripped with the gripper.

### Aspect 15

In Aspect 15, the sheet processing apparatus according to Aspect 14 further includes a guide, disposed on the at least one of the first branched conveyance passage or the second branched conveyance passage, to guide one of the first sheet and the second sheet to the gripper of the winder.

### Aspect 16

In Aspect 16, in the sheet processing apparatus according to Aspect 15, the guide is movable between a guiding position to guide one of the first sheet and the second sheet conveyed to corresponding one of the first branched conveyance passage and the second branched conveyance passage, to the gripper of the winder and a retracted position farther from the winder than the guiding position to enable the winder to wind one of the first sheet and the second sheet.

### Aspect 17

In Aspect 17, in the sheet processing apparatus according to any one of Aspects 14 to 16, the gripper is movable between a gripping position at which the gripper grips the leading end of one of the first sheet and the second sheet and a standby position at which the gripper is separated from the gripping position.

### Aspect 18

In Aspect 18, in the sheet processing apparatus according to Aspect 17, the gripper moves from the standby position to the gripping position in conjunction with a movement of the guide from the guiding position to the retracted position.

### Aspect 19

In Aspect 19, in the sheet processing apparatus according to any one of Aspects 14 to 18, the winder has a wedge-shaped gripper that grips one of the first sheet and the second sheet conveyed to the corresponding one of the first branched conveyance passage and the second branched conveyance passage, with a leading end in the conveyance direction of one of the first sheet and the second sheet contacting the winder.

### Aspect 20

In Aspect 20, in the sheet processing apparatus according to any one of Aspects 15 to 19, the main conveyance passage includes a pre-separation conveyance passage, upstream from the main conveyance passage in the conveyance direction, to which the two-ply sheet is conveyed prior to the sheet separating operation. The first branched conveyance passage and the second branched conveyance passage are disposed on opposite sides across the pre-separation conveyance passage. The guide guides the two-ply sheet in the pre-separation conveyance passage when the guide is at the guiding position.

### Aspect 21

In Aspect 21, in the sheet processing apparatus according to any one of Aspects 15 to 20, the winder includes the roller around which one of the first sheet and the second sheet is wound, and the guide has a curved face curved in a direction along an outer circumference of the roller.

### Aspect 22

In Aspect 22, the sheet processing apparatus according to any one of Aspects 14 to 21 further includes a conveyance roller pair to convey the first sheet of the two sheets separated from each other to the first branched conveyance passage, and convey the second sheet of the two sheets separated from each other to the second branched conveyance passage. The winder has a first sheet conveyance speed in a winding operation faster than a second sheet conveyance speed of the conveyance roller pair.

### Aspect 23

In Aspect 23, the sheet processing apparatus according to any one of Aspects 14 to 22 further includes a detector to detect an end of the sheet winding operation by the winder.

### Aspect 24

In Aspect 24, the sheet processing apparatus according to Aspect 23 further includes a conveyance roller pair and circuitry. The conveyance roller pair conveys the two sheets separated from each other to the first branched conveyance passage and the second branched conveyance passage. The circuitry is to perform a sheet inserting operation to cause the conveyance roller pair to grip the bonded portion of the two-ply sheet and rotate in a direction opposite to the conveyance direction in response to a detection of the end of the sheet winding operation by the winder, and insert an inner sheet between the two sheets separated from each other.

### Aspect 25

In Aspect 25, the sheet processing apparatus according to any one of Aspects 14 to 22 further comprising a sheet lamination device to perform a sheet laminating operation on the two-ply sheet with the inner sheet inserted between the two sheets by the sheet separation device.

### Aspect 26

In Aspect 26, an image forming system includes the sheet processing apparatus according to any one of Aspects 14 to 25, and an image forming apparatus to form an image on an inner sheet to be conveyed to the sheet processing apparatus.

### Aspect 27

In Aspect 27, a sheet laminator includes the sheet processing apparatus according to Aspect 14, and a thermal fixer to perform a sheet laminating operation on the two-ply sheet having an inner sheet inserted between the two sheets by the sheet separation device.

### Aspect 28

In Aspect 28, an image forming system includes the sheet laminator according to Aspect 27, and an image forming apparatus to form an image on an inner sheet to be conveyed to the sheet laminator.

The present disclosure is not limited to specific embodiments described above, and numerous additional modifications and variations are possible in light of the teachings within the technical scope of the appended claims. It is therefore to be understood that, the disclosure of this patent specification may be practiced otherwise by those skilled in the art than as specifically described herein, and such, modifications, alternatives are within the technical scope of the appended claims. Such embodiments and variations thereof are included in the scope and gist of the embodiments of the present disclosure and are included in the embodiments described in claims and the equivalent scope thereof.

The effects described in the embodiments of this disclosure are listed as the examples of preferable effects derived from this disclosure, and therefore are not intended to limit to the embodiments of this disclosure.

The embodiments described above are presented as an example to implement this disclosure. The embodiments described above are not intended to limit the scope of the invention. These novel embodiments can be implemented in various other forms, and various omissions, replacements, or changes can be made without departing from the gist of the invention. These embodiments and their variations are included in the scope and gist of this disclosure and are included in the scope of the invention recited in the claims and its equivalent.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

What is claimed is:

1. A sheet processing apparatus comprising:
a main conveyance passage to convey a two-ply sheet having two sheets overlapped and bonded together at a bonding portion in a conveyance direction;
a first branched conveyance passage branched from the main conveyance passage in a first direction;
a second branched conveyance passage branched from the main conveyance passage in a second direction different from the first direction;
a sheet separation device to:
separate a non-bonding portion of the two-ply sheet;
convey a first sheet of the two sheets separated from each other to the first branched conveyance passage; and
convey a second sheet of the two sheets separated from each other to the second branched conveyance passage; and
a winder disposed on at least one of the first branched conveyance passage or the second branched conveyance passage to rotate and wind one of the first sheet and the second sheet, and
the winder including:
a gripper attached to the winder to grip a leading end, in one of the first direction or the second direction, of one of the first sheet and the second sheet conveyed to corresponding one of the first branched conveyance passage and the second branched conveyance passage by the sheet separation device.

2. The sheet processing apparatus according to claim 1, further comprising a guide, disposed on the at least one of the first branched conveyance passage or the second branched conveyance passage, to guide one of the first sheet and the second sheet to the gripper of the winder.

3. The sheet processing apparatus according to claim 2,
wherein the guide is movable between:
a guiding position to guide one of the first sheet and the second sheet, conveyed to corresponding one of the first branched conveyance passage and the second branched conveyance passage, to the gripper of the winder; and
a retracted position farther from the winder than the guiding position to enable the winder to wind one of the first sheet and the second sheet.

4. The sheet processing apparatus according to claim 1,
wherein the gripper is movable between:
a gripping position at which the gripper grips the leading end of one of the first sheet and the second sheet; and
a standby position at which the gripper is separated from the gripping position.

5. The sheet processing apparatus according to claim 4,
wherein the gripper moves from the standby position to the gripping position in conjunction with a movement of the guide from the guiding position to the retracted position.

6. The sheet processing apparatus according to claim 1,
wherein the winder has a wedge-shaped gripper that grips one of the first sheet and the second sheet conveyed to the corresponding one of the first branched conveyance passage and the second branched conveyance passage, with a leading end in the conveyance direction of one of the first sheet and the second sheet contacting the winder.

7. The sheet processing apparatus according to claim 2,
wherein the main conveyance passage includes a pre-separation conveyance passage, upstream of the main conveyance passage in the conveyance direction, to which the two-ply sheet is conveyed prior to the sheet separating operation,
the first branched conveyance passage and the second branched conveyance passage are disposed on opposite sides across the pre-separation conveyance passage, and
the guide guides the two-ply sheet in the pre-separation conveyance passage when the guide is at the guiding position.

8. The sheet processing apparatus according to claim 2,
wherein the winder includes a roller around which one of the first sheet and the second sheet is wound; and
the guide has a curved face curved in a direction along an outer circumference of the roller.

9. The sheet processing apparatus according to claim 1, further comprising a conveyance roller pair to:
convey the first sheet of the two sheets separated from each other to the first branched conveyance passage; and
convey the second sheet of the two sheets separated from each other to the second branched conveyance passage,
wherein the winder has a first sheet conveyance speed in a winding operation faster than a second sheet conveyance speed of the conveyance roller pair.

10. The sheet processing apparatus according to claim 1, further comprising a detector to detect an end of the sheet winding operation by the winder.

11. The sheet processing apparatus according to claim 10, further comprising:
a conveyance roller pair to convey the two sheets separated from each other to the first branched conveyance passage and the second branched conveyance passage; and
circuitry configured to perform a sheet inserting operation to:
cause the conveyance roller pair to grip the bonded portion of the two-ply sheet and rotate in a direction opposite to the conveyance direction in response to a detection, detected by the detector, of the end of the sheet winding operation by the winder; and
insert an inner sheet between the two sheets separated from each other.

12. The sheet processing apparatus according to claim 1, further comprising a sheet lamination device to perform a sheet laminating operation on the two-ply sheet with the inner sheet inserted between the two sheets by the sheet separation device.

13. An image forming system comprising:
the sheet processing apparatus according to claim 1; and
an image forming apparatus to form an image on an inner sheet to be conveyed to the sheet processing apparatus.

14. A sheet laminator comprising:
the sheet processing apparatus according to claim 1; and
a thermal fixer to perform a sheet laminating operation on the two-ply sheet having an inner sheet inserted between the two sheets by the sheet separation device.

15. An image forming system comprising:
the sheet laminator according to claim 14; and
an image forming apparatus to form an image on an inner sheet to be conveyed to the sheet laminator.
